(19) United States
(12) Patent Application Publication
(10) Pub. No.: US 2008/0127775 A1
(43) Pub. Date: Jun. 5, 2008

(54) Inertiatrons and methods and devices using same

(76) Inventor: Paul D. Stoner, Powell, OH (US)

Correspondence Address: FAY SHARPE LLP, 1100 SUPERIOR AVENUE, SEVENTH FLOOR, CLEVELAND, OH, 44114, US

(21) Appl. No.: 11/800,320

(22) Filed: May 4, 2007

Related U.S. Application Data
(63) Continuation-in-part of application No. 10/736,869, filed on Dec. 16, 2003.
(60) Provisional application No. 60/434,755, filed on Dec. 18, 2002.
(60) Provisional application No. 60/518,797, filed on Nov. 10, 2003.

(51) Int. Cl. F03G 3/00; F16H 33/20

(52) U.S. Cl. 74/84 R

(57) ABSTRACT

A thruster includes a mass following a trajectory confined to a preselected volume, and a brake selectively applied to decelerate the mass over a selected portion of the trajectory. In one embodiment, a plurality of such thrusters are ganged together to define a thruster device. In one embodiment, the thruster device is used to propel a vehicle such as a wheeled vehicle, an airplane, a boat, a ship, a flying car, a submarine, or a spacecraft. In one embodiment the trajectory-mass consists of a plasma of elementary charged particles. The thruster exhibits a side effect that it thrusts in the reverse direction when being charged. Accordingly, the thruster must be connected to a larger companion mass (such as the earth) during its charging cycle. It must move that mass in the reverse direction so that at a later time it can move itself in the forward direction without ejecting any of the trajectory-mass from itself. In this manner, the center of mass remains unchanged. A practical consequence of the reverse thrust side-effect is explained using the following example: When a vehicle such as a flying car is fitted with inertiatrons to provide upward lifting propulsion, the side effect is that the whole vehicle appears to weigh more during its charging cycle (e.g., a 5000 pound flying car might weight 8000 pounds or more) for several minutes or hours before it can be flown or driven.

This application is a continuation-in-part of U.S. patent application Ser. No. 10/736,869 filed Dec. 16, 2003, which in turn claims the benefit and priority of U.S. Provisional Application Ser. No. 60/434,755 of inventor Paul D. Stoner, entitled “Giant Half Cycle-Inertia Propulsion”, filed on Dec. 18, 2002. This application also is a continuation-in-part of U.S. patent application Ser. No. 10/736,869 filed Dec. 16, 2003, which in turn claims the benefit and priority of U.S. Provisional Application Ser. No. 60/518,797 of inventor Paul D. Stoner, entitled “Inertial Propulsion and Storage System”, filed on Nov. 10, 2003.

### BACKGROUND OF THE INVENTION

The present invention relates to the mechanical and energy storage arts. In particular, the present invention is directed to the propulsion of land, air, space, and/or water vehicles; elevators; parachutes; and other lifting and/or propulsion devices, and so forth, as well as to energy storage system, and will be described with particular reference to such applications. However, other applications will benefit from the disclosed, internally contained, substantially pollution-free mechanical thrust units that optionally can be continuously throttled from zero thrust to a maximum thrust. Moreover, still yet other applications will benefit from the disclosed from, internally contained electrical/mechanical energy converters.

Existing mechanical thrust units, such as propellers, screw drives, mechanically driven wheels, and the like, have various disadvantages. Propellers and screw drives operate against an ambient fluid such as air or water, and are inoperative outside of such ambient fluid. Similarly, a wheel depends upon frictional contact with a solid surface. The effectiveness of propellers, screw drives, and the like depend upon properties of the ambient fluid, and may operate differently at different altitudes or water depths due to differences in pressure or other ambient properties. Similarly, thrust provided by a driven wheel depends upon frictional contact with the solid surface, and can be reduced or wholly lost if that surface becomes coated with ice, oil, or another low-friction coating. Propellers and screw drives produce substantial turbulence in the ambient fluid, which can cause stability problems. Such turbulence can also be a problem for clandestine applications, since the turbulence can be tracked to locate the vehicle. Operation of driven wheels is generally limited to roads or other controlled and spatially limited solid surfaces.

Moreover, propellers, screw drives, driven wheels, and the like do not directly provide mechanical thrust. Rather, such devices are operated by an internal combustion engine, electric motor, or the like. Engines and motors are typically noisy. Internal combustion engines produce exhaust that contaminates the environment. Engines and motors are also mechanically complex and thus prone to mechanical breakdown. The moving parts of engines and motors can also present a safety hazard. Engines and motors do not inherently produce thrust; rather, an engine or motor is coupled to a propeller, screw drive, wheels, or the like via a drive shaft to convert the reciprocating mechanical motion of the engine or motor into usable mechanical thrust.

A rocket engine is another device for producing mechanical thrust. Rocket engines depend upon expulsion of a working mass, such as a working gas or gases, to drive the rocket in a direction opposite from the direction of expulsion of the working mass. The expelled gas creates turbulence in the environment. Depending upon its composition, the expelled gas can also contaminate the environment. Furthermore, rocket engine operation typically involves violent chemical reactions that forcefully generate the expelled gases. These violent chemical reactions can present a safety hazard if they get out of control. Rocket engines are also generally noisy. Still further, it is sometimes difficult to controllably throttle a rocket engine.

A jet engine is yet another device for producing mechanical thrust. The jet engine includes a turbine driven by an engine or motor that expels air at elevated pressure to provide thrust. Jet engines produce turbulence, are noisy, and are mechanically complex.

All of the above-described mechanical thrust devices also have the potential to suffer catastrophic failure in which thrust is abruptly lost. This is particularly true in the case of devices driven by internal combustion engines or electric motors, due to the complexity of the driving engine or motor. Catastrophic loss of thrust can be dangerous or even fatal in the case of airplanes, submarines or other vehicles that depend upon constant, controlled thrust for safe operation. The above-described mechanical thrust devices, excepting rocket engines, also operate in conjunction with a working fluid or solid surface, and thus are inoperative in space.

Another difficulty with the above-described thrust devices is that they typically employ substantial amounts of fuel. Rockets, for example, are limited in range by the amount of propellant, while internal combustion engines are limited by the amount of combustible fuel carried on the vehicle. This is a substantial limitation for space-based operations. Although solar energy is available in space, the above-described thrust devices are generally unable to capture and make use of solar energy.

The present invention contemplates an improved apparatus and method which overcomes the aforementioned limitations and others.

### SUMMARY OF THE INVENTION

The present invention is directed to a thruster that includes a mass following a trajectory confined to a preselected volume, and a brake selectively applied to decelerate the mass over a selected portion of the trajectory. The present invention encompasses the use of a single thruster or a plurality of such thrusters that are ganged together to define a thruster device. The one or more thrusters of the present invention can be used to propel, stop or slow a vehicle such as a wheeled vehicle, an airplane, a boat, a ship, a submarine, a spacecraft, and many other devices. In one embodiment of the invention, there is provided a housing that defines the preselected volume, and the brake is at least partially secured to the housing. In another and/or alternative embodiment of the invention, a track disposed inside the housing and is at least partially secured to the housing wherein the track constrains the mass to follow the trajectory. In still another and/or alternative embodiment of the invention, the brake has a braking mode in which the brake decelerates the mass over the selected portion of the trajectory. In one aspect of this embodiment, the brake comprises a decelerator operative when the brake is in the braking mode. In yet another and/or alternative embodiment of the invention, the brake has an accelerating mode in which the brake accelerates the mass over the selected portion of the trajectory. In one aspect of this embodiment, an accelerator is operative when the brake is in the accelerating mode.

In another aspect of the present invention, there is provided an apparatus and method that includes first plurality of thrusters; and a second plurality of thrusters; the brakes of the first plurality of thrusters being in the accelerating mode when the brakes of the second plurality of thrusters are in the decelerating mode; and the brakes of the second plurality of thrusters being in the accelerating mode when the brakes of the first plurality of thrusters are in the decelerating mode. In one embodiment of the invention, the brakes of the plurality of thrusters are at least partially secured to a support and exert a force on the support during the accelerating or decelerating operation. In one aspect of this embodiment, the brakes of the plurality of thrusters are secured to the support such that a net force exerted on the support with the brakes in the accelerating mode is substantially zero, and a non-zero net thrust force is exerted on the support with the brakes in the decelerating mode.

In still another and/or alternative aspect of the present invention, there is provided an apparatus and method that includes a plurality of groups of thrusters and supports, the brakes of each group of thrusters being at least partially secured to the supports and exerting a brake force on the supports during the accelerating or decelerating. The brakes of each thruster of each group of thrusters are configured so that the brake force exerted on the support by each group of thrusters is substantially zero with the brakes of the group of thrusters in the accelerating mode. A group thrust force is exerted with the brakes of the group of thrusters in the decelerating mode. Timing circuitry is further included that selectively switches the plurality of groups of thrusters to apply thrust to the support using at least one group of thrusters while at least one other group of thrusters has its brakes in the accelerating mode.

In yet another and/or alternative aspect of the present invention, there is provided an apparatus and method that includes a throttle controlling the brake between zero deceleration and a maximum deceleration. In one embodiment of the invention, the throttle controls the brake to provide a deceleration selected from a continuum of decelerations ranging between zero deceleration and the maximum deceleration. In another and/or alternative embodiment of the invention, the throttle controls the brake between a maximum deceleration over the selected portion of the trajectory and a maximum acceleration applied to the mass over the selected portion of the trajectory.

In still yet another and/or alternative aspect of the present invention, there is provided an apparatus and method that accelerates and/or decelerates a mass that includes charged particles by one or more thrusters.

In a further and/or alternative aspect of the present invention, there is provided an apparatus and method that includes an electrostatic brake that electrostatically decelerates a mass over the selected portion of the trajectory of the mass.

In still a further and/or alternative aspect of the present invention, there is provided an apparatus and method that includes a magnetic brake magnetically decelerating the mass over the selected portion of the trajectory of the mass.

In yet a further and/or alternative aspect of the present invention, there is provided an apparatus and method that includes a confinement device that generates a confining magnetic field constraining the plurality of charged particles to follow the trajectory.

In still yet a further and/or alternative aspect of the present invention, there is provided an apparatus and method that includes a confinement device that generates a confining electrostatic field constraining the plurality of charged particles to follow the trajectory.

In another and/or alternative aspect of the present invention, there is provided an apparatus and method that includes an evacuated housing enclosing at least the trajectory; and an electron source sourcing a plurality of accelerated electrons defining the mass.

In still another and/or alternative aspect of the present invention, there is provided an apparatus and method that includes a substrate disposed in the evacuated housing and having an electrically biased track disposed thereon, the track constraining the accelerated electrons to follow the trajectory. In one embodiment of the invention, there is provided a plurality of thrusters and a common support of the substrate, and the brakes of the thrusters being substantially rigidly secured to the common support. In another and/or alternative embodiment of the invention, there is provided a plurality of thruster wherein each thruster includes a confinement disposed on the common support, the confinement restricting the mass to follow the trajectory. In still another and/or alternative embodiment of the invention, the common support includes a plurality of generally planar substrates that are secured together.

In yet another and/or alternative aspect of the present invention, there is provided an apparatus and method that includes a substantially rigid support onto which a plurality of thrusters are secured, and the brake of each thruster applies a force to the support in a selected direction when the brake is applied; and a rotatable or gimbal mount is connected to the support. The rotatable or gimbal mount is selectively angularly positioned relative to the vehicle.

One object of the present invention is an apparatus and method that includes a thruster having a mass following a trajectory confined to a preselected volume, and a brake selectively applied to decelerate the mass over a selected portion of the trajectory.

Another and/or alternative object of the present invention is an apparatus and method of applying force to an associated object.

Still another and/or alternative object of the present invention is an apparatus and method of using a plurality of masses accelerated along one or more trajectories confined within a selected volume wherein each of the moving masses are repeatedly decelerated to produce a counter-force applied to the associated object.

Yet another and/or alternative object of the present invention is an apparatus and method of using an inertiatron to thrust, stop and/or slow an object.

Numerous advantages and benefits of the present invention will become apparent to those of ordinary skill in the art upon reading the following detailed description of the preferred embodiments.

### BRIEF DESCRIPTION OF THE DRAWINGS

The invention may take form in various components and arrangements of components, and in various process operations and arrangements of process operations. The drawings are only for the purpose of illustrating preferred embodiments and are not to be construed as limiting the invention.

FIGS. 1A, 1B, and 1C diagrammatically show a thrust device employing linear motion of inner masses;

FIGS. 2A and 2B diagrammatically show the charging sub-cycle and the thrust sub-cycle, respectively, of a thrust device employing inner masses following closed loop paths or trajectories;

FIG. 3 diagrammatically shows an alternative charging sub-cycle for the thrust device of FIGS. 2A and 2B, in which the accelerations are synchronously balanced;

FIGS. 3A and 3B provide a diagrammatic comparison between a balanced-charged inertial propulsion system (FIG. 3A) and an unbalanced-charging inertial propulsion system (FIG. 3B).

FIGS. 4A and 4B show a thrust device employing macroscopic inner masses;

FIG. 5 shows another thrust device employing macroscopic inner masses;

FIG. 6 diagrammatically shows an inertiatron employing electrons of an electron beam as inner masses;

FIG. 7 plots forces exerted by one of the electrons of the electron beam of the inertiatron of FIG. 6;

FIG. 8 diagrammatically shows an inertiatron device containing a large plurality of inertiatrons arranged on a plurality of substrate sheets and hermetically sealed in an outer container;

FIG. 9 diagrammatically shows a thrust device employing two inertiatron devices that are operated in a repeating ping-pong sequence to provide continuous thrust;

FIG. 10 plots forces exerted by the two ping-ponged inertiatron devices and also plots the sum of forces exerted by the two ping-ponged inertiatron devices;

FIG. 11 plots forces exerted by three inertiatrons that are cooperatively operated in a time-phased manner to reduce force pulsations;

FIGS. 12A, 12B, and 12C diagrammatically show a vehicle employing a pivotable or rotatable inertiatron device for steerable propulsion;

FIG. 13 diagrammatically shows another vehicle employing fixed, ping-ponged inertiatron devices for propulsion and a steering column or shaft for steering;

FIG. 14 plots a number of applications of inertiatron devices against thrust time and sustained thrust output suitable for those applications;

FIG. 15 diagrammatically shows a self-leveling levitating platform.

FIG. 16 diagrammatically shows a satellite with an inertiatron device for providing steering and rotational thrust force;

FIG. 17 diagrammatically show charged particles in a single track inertiatron are creating a magnetic field;

FIG. 18 diagrammatically show a plurality of charged-particle-type inertiatrons arranged in a circle;

FIG. 19 illustrates a cutaway view of a more elegant mechanical design for a torrid in accordance with the present invention; and,

FIG. 20 illustrates a cutaway view of a another mechanical design for a torrid in accordance with the present invention.

### DETAILED DESCRIPTION OF THE NON-LIMITING EMBODIMENTS

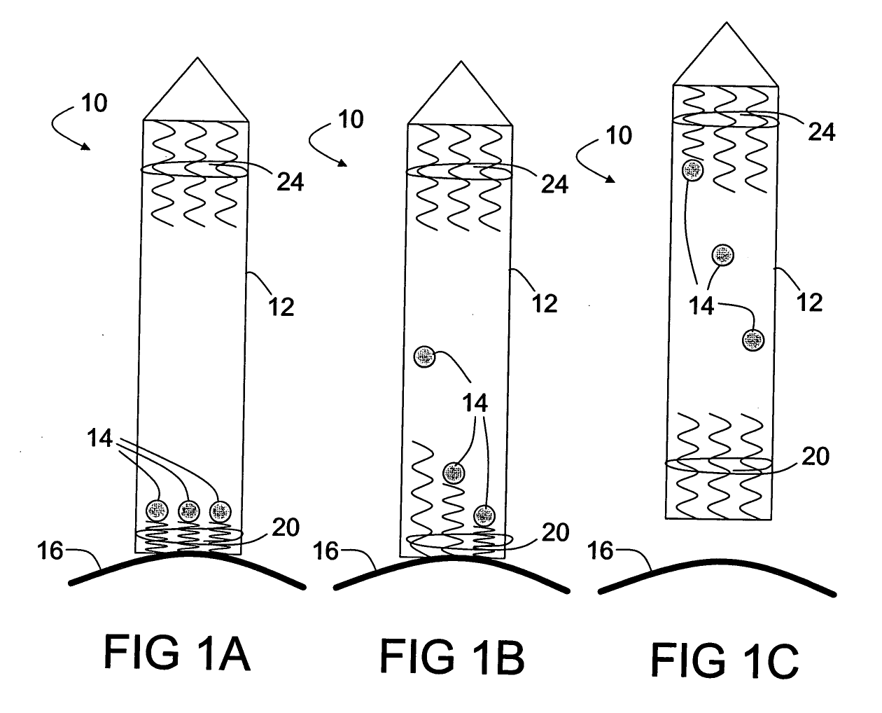

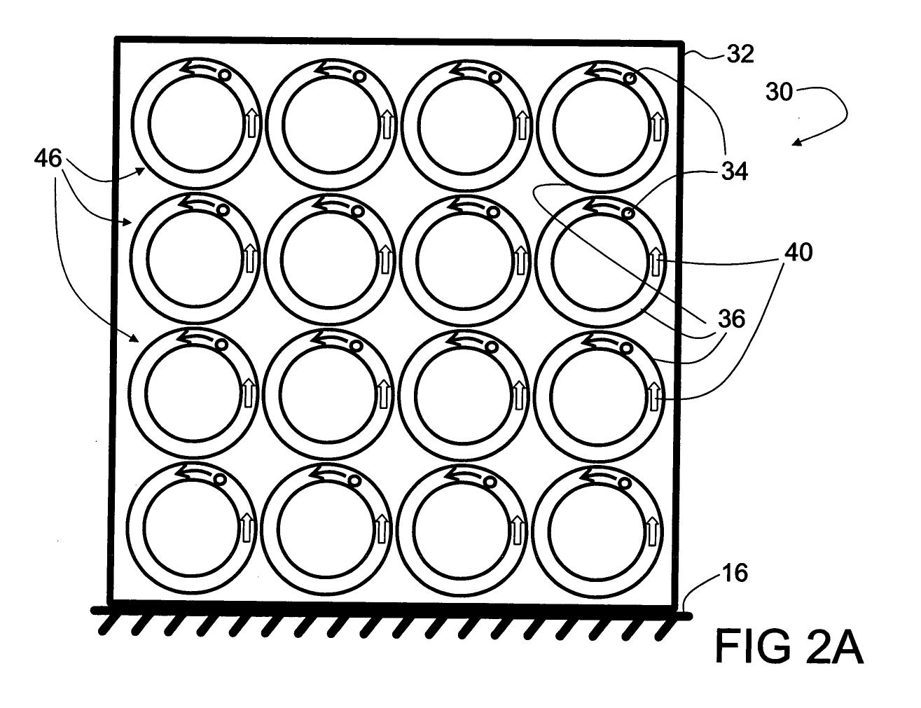

Referring now to the drawings wherein the showings are for the purpose of illustrating the preferred embodiments only and not for the purpose of limiting same, FIGS. 1A, 1B, and 1C illustrate a thrust device 10 includes a housing 12 and a plurality of inner masses 14. In FIGS. 1A and 1B, the device 10 rests on the ground 16. In FIG. 1A, the inner masses 14 are compressed against springs 20. It will be appreciated that energy is used during compression of the springs 20 to obtain the configuration of FIG. 1A in which the springs 20 are poised to accelerate the inner masses 14. In the configuration of FIG. 1A, the thrust device 10 contains stored mechanical energy in the form of the compressed springs 20. The compressed springs 20 are prevented from releasing this stored energy by a suitable restraint (not shown).

In FIG. 1B, the restraint is released, allowing the compressed springs 20 to release the stored mechanical energy by expanding and exerting forces on the inner masses 14 that accelerate the inner masses 14 away from the ground 16. In accordance with Newton's law that for every force acting on a mass there is an equal and opposite force acting on another mass, the upward force against the inner masses 14 correlates with a downward force that the springs 20 exert on the bottom of the housing 12 and, through the housing 12, against the ground 16. However, the ground 16, being much more massive than the masses 14, experiences substantially no acceleration responsive to this force. It will be appreciated that during the release of the stored energy, the housing 12 appears to become “heavier” as it exerts a greater force against the ground 16.

In one embodiment, the springs 20 are not all released simultaneously. Rather, the release of the springs is staggered in time. This results in the inner masses 14 being accelerated away from the ground 16 at staggered times, as shown in FIG. 1B. Once all the inner masses 14 have been released, there is no longer any force exerted by the springs 20 tending to press the housing 12 against the ground 16. The thrust device 10 therefore returns to its usual “weight,” while the inner masses 14 continue to travel away from the ground 16 within the housing 12.

With reference to FIG. 1C, each accelerated inner mass 14 follows a trajectory that is confined to the volume of the housing 12. As each of the upwardly accelerated inner masses 14 reaches the end of the housing 12 opposite the ground 16, it impinges upon one of a plurality of receiving springs 24. As each inner mass 14 hits the receiving spring 24, it compresses the spring 24. The compressing spring exerts a decelerating force against the inner mass 14, and also exerts an accelerating force against a top of the housing 12 that tends to accelerate the housing 12 away from the ground 16. By staggering the release of the bottom springs 20, this accelerating force against the housing 12 is staggered in time, producing a force on the housing 12 that tends to thrust the housing 12 away from the ground 16. If the force of this thrust is greater than the weight of the housing 12, then the thrust device 10 lifts away from the ground 16, as shown in FIG. 1C. The earth 16 can be viewed as a propellant mass that is ejected from the thrust device 10.

The time over which the thrust device 10 provides thrust is limited to the time it takes the inner masses 14 to traverse the length of the housing 12 and additionally finish compressing the receiver springs 24. The device 10 relies upon the ground 16 during release of the springs 20 to prevent the housing 12 from initially accelerating in the “wrong” direction. In space, for example, the release of the springs 20 would cause a first motion of the housing 12, and impingement of the inner masses 14 on the opposite springs 14 would cause a second, opposite motion of the housing 12. No net motion of the housing 12 is achieved in space for the embodiment of FIGS. 1A, 1B, and 1C.

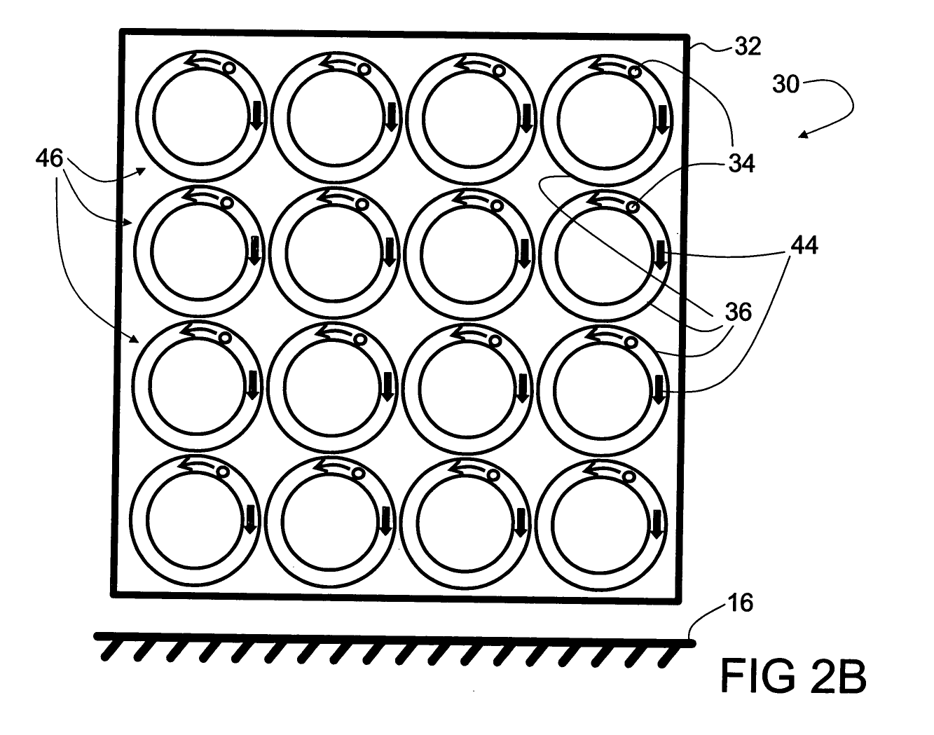

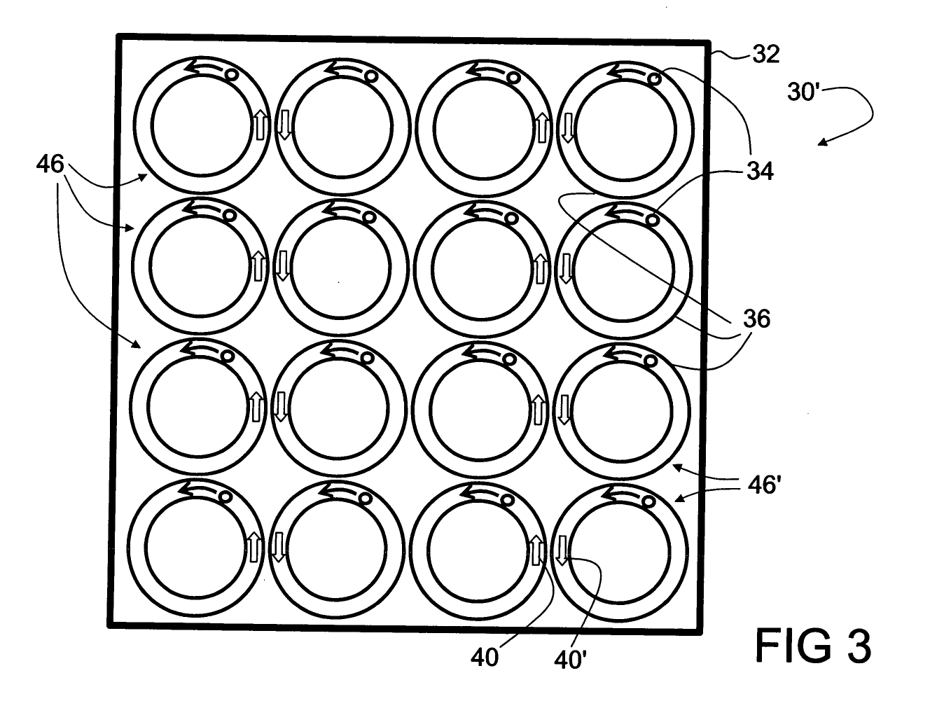

With reference to FIGS. 2A and 2B, a thrust device 30 includes a housing 32 containing inner masses 34 each following closed loop trajectories or paths 36 contained within the housing 32. As shown in FIG. 2A, the housing 32 initially rests on the ground 16. During a charging sub-cycle shown in FIG. 2A, the inner masses 34 are accelerated in a counter-clockwise direction by accelerators 40. The accelerators 40 are indicated diagrammatically by unfilled arrows indicating the direction of generated acceleration of the inner masses 34. The accelerators 40 are secured to the housing 32 so that the accelerating force applied by the accelerators 40 to the masses 34 has a corresponding equal and opposite force exerted on the housing 32 and thence exerted onto the ground 16. Thus, during the charging sub-cycle of FIG. 2A, the thrust device 30 appears “heavier” than usual.

Each accelerator 40 suitably accelerates the inner mass 34 each time the mass 34 passes through the acceleration region of the closed loop trajectory or path 36. Even if the acceleration applied is relatively modest, the masses 34 can be built up to a high speed through repetitive accelerations each time the mass 34 passes through the acceleration region of the trajectory or path 36. Moreover, once the inner masses 34 have been accelerated to a selected speed, the accelerators 40 can be turned off. In the absence of frictional losses, each mass 34 continues to follow the closed loop path or trajectory 36, so that energy is stored in the thrust device 30 once the charging sub-cycle of FIG. 2A is complete. Moreover, once the accelerators 40 are turned off, no net force is exerted on the housing 32, and so the thrust device 30 returns to its usual weight. The inner masses 34 do experience forces that keep the masses 34 on the trajectory 36 and corresponding counterforces are exerted on the housing 32; however, it will be appreciated that these forces average out to zero during each completed circuit of the trajectory 36.

With reference to FIG. 2B, when thrust is desired, decelerators 44 are applied in what was previously the acceleration region. The decelerators 44 are indicated diagrammatically by filled arrows indicating the direction of generated deceleration of the inner masses 34. The direction of deceleration produced by the decelerators 44 is generally opposite the direction of the acceleration produced by the accelerators 40 of FIG. 2A.

The decelerators 44 are secured to the housing 32 so that the decelerating force applied by the decelerators 44 to the masses 34 has a corresponding equal and opposite force exerted on the housing 32. This force is opposite to the force exerted on the housing 32 during the charging sub-cycle, and tends to move the thrust device 30 away from the ground 16. Thus, during the thrust sub-cycle of FIG. 2B, the thrust device 30 appears “lighter” than usual. If the deceleration force is large enough, it overcomes the weight of the thrust device 30 and lifts the thrust device 30 off the ground, as shown in FIG. 2B.

Each decelerator 44 suitably decelerates the inner mass 34 each time the mass 34 passes through the deceleration region of the closed loop trajectory or path 36. If the deceleration applied is relatively modest, it slows, but does not stop, the masses 34 over a single pass of the deceleration region. Thus, as each mass 34 follows its closed loop path 36, it repeatedly passes through the deceleration region and experiences a deceleration. Each deceleration produces a corresponding force on the housing 32. In the embodiment of FIGS. 2A and 2B, the thrust can be extended over a period of time corresponding to the time it takes for the repeated decelerations to slow the inner masses 34 to zero velocity.

Moreover, the amount of thrust can be throttled from zero to a maximum thrust, by changing the amount of deceleration produced by the decelerators 44. For example, the decelerators 44 can be turned off at any time, thus turning off the thrust. A reverse thrust can be obtained by turning off the decelerators 44 and turning the accelerators 40 back on. Throttling can also be obtained by applying a fraction of the decelerators 44 so that only some of the inner masses 34 are decelerated. In this approach, applying all the decelerators 44 provides maximum thrust; applying none of the decelerators 44 provides zero thrust, and thrust values intermediate between zero and the maximum thrust are obtained by applying a selected fraction of decelerators 44.

The embodiment of FIGS. 2A and 2B can be constructed in various ways. In one construction, the masses are balls being moved along a circular track corresponding to the closed loop path or trajectory 36. The accelerators 40 and decelerators 44 can be pressurized air jets, mechanical brakes exerting frictional decelerating force on the inner masses 34, or the like. In one arrangement, the accelerator 40 and decelerator 44 for each inner mass 34 is embodied by the same physical element.

In another construction, the masses are charged particles constrained to circular or other closed path trajectories by electric or magnetic fields. For example, the trajectory 36 can be defined by a circular or other closed path wall that is electrostatically biased to repel the charged inner masses 34, or the trajectory 36 can be a circular trajectory defined by a magnetic field according to F_{mag}=qv×B where q is the charge of the inner mass 34, v is the velocity of the inner mass 34, and B is a magnitude of a confining magnetic field directed perpendicular to the plane of the trajectory 36. The accelerators 40 and decelerators 44 are suitably embodied by electrostatic or magnetic field generators, and may be embodied by a single element that can be reversed to provide either acceleration or deceleration.

With returning reference to FIGS. 2A and 2B, operation of the thrust device 30 can also be described in terms of giant half-cycle inertial propulsion. During the charging sub-cycle shown in FIG. 2A, an inner cycle is defined by the motion and acceleration of the inner masses 34. The overall charging of the thrust device 30 by operation of the inner cycles of the plurality of masses 34 defines a first giant half-cycle. During this first giant half-cycle, the thrust device 30 pushes against the ground 16. In effect, it ejects the ground 16, although the ejecting of the ground 16 is imperceptible due to the large mass of the earth and is in effect absorbed by the earth. The reaction force created by ejection of the mass of the ground 16 is stored in the motion of the inner masses 34. Activation of the decelerator or brake 44 during the thrust sub-cycle shown in FIG. 2B uses the stored reaction force to provide thrust for the thrust device 30.

Herein, the term “inertiatron” will be used to designate the inner-cycle closed system including the inner mass or masses and associated accelerator and decelerator, in which the decelerator is arranged to produce a cumulative thrust force in a selected direction by repetitive deceleration events applied to the inner mass or masses. For example, in FIGS. 2A and 2B, each inner mass 34 following the closed loop path or trajectory 36 along with its associated accelerator 40 and decelerator 44 define an inertiatron 46. In the thrust device 30 of FIGS. 2A and 2B there are sixteen inertiatrons 46. While each inertiatron 46 in FIGS. 2A and 2B includes a single inner mass 34, other embodiments described herein include a plurality of inner masses, such as an electron beam of electrons in which the electrons serve as inner masses.

With reference returning to FIG. 2A, it will be appreciated that during the charging sub-cycle there is a net force on the housing 12 directed toward the ground 16. That is, the thrust device 30 appears “heavier” than normal during the charging sub-cycle. This net force is countered by the ground 16 or another suitable restraint.

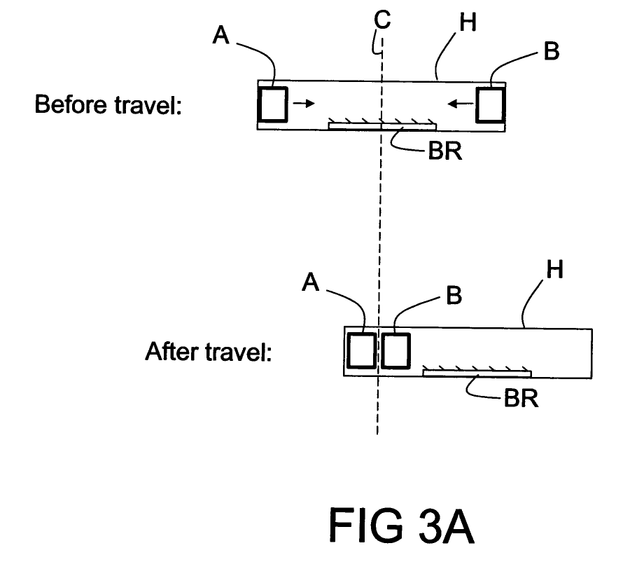

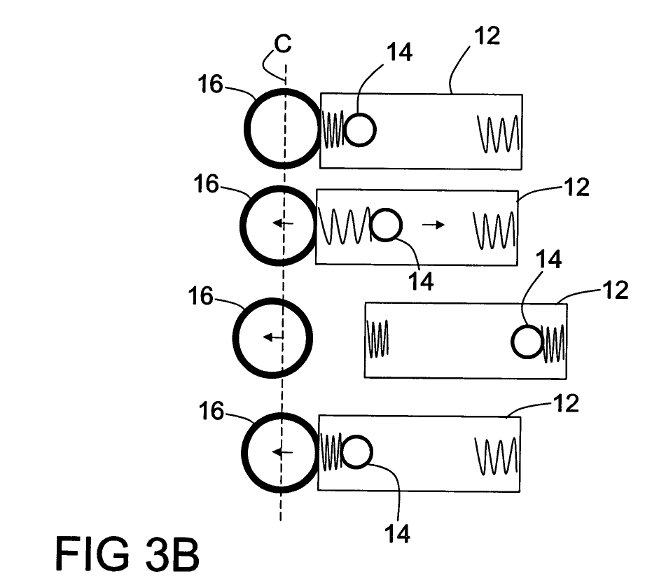

With reference to FIG. 3, a slightly modified thrust device 30′ is substantially similar to the thrust device 30 of FIGS. 2A and 2B, with the difference that about one-half of the inertiatrons 46′ have accelerators 40′ secured to the housing 12. The accelerators 40′ differ from the accelerators 40 in that they are relatively displaced by about a half-turn around the trajectory 36 from where the accelerators 40 are positioned. As a result, the accelerators 40′, like the accelerators 40, accelerate the corresponding inner masses 34 in a counter-clockwise direction. However, because of the relative displacement of accelerators 40 and accelerators 40′, the accelerators 40 and the accelerators 40′ exert oppositely directed forces on the housing 12. Thus, the net force on the housing 12 during the charging cycle illustrated in FIG. 3 is substantially zero. The thrust device 30′ can undergo its charging sub-cycle in space without a ground 16 or other restraint, and can occur in space without causing movement of the thrust device. The thrust sub-cycle of the thrust device 30′ is substantially the same as that illustrated in FIG. 2B for the device 30. That is, during the thrust sub-cycle half the decelerators 44 are arranged to produce forces on the housing 12 in generally the same direction, so that a net force or thrust is imposed on the housing 12 during the thrust sub-cycle.

An arrangement such as that shown in FIG. 3, in which acceleration counter-forces are balanced to avoid a substantial net force on the housing during the energy storage sub-cycle is called herein “balanced charging.” The vehicle generally does not shake during charge-up using balanced charging. Although balanced charging provides certain benefits, balanced charging provides a travel distance limited by conservation of momentum. The vehicle travel distance is limited to about one-half the longest part of the inertiatron path length.

With reference to FIG. 3A, the travel distance limit imposed by balanced charging is diagrammatically described. Inner masses A and B move in opposite directions within a housing tube H. The assembly is centered about center of gravity C. To conserve momentum, the center of mass C for the thrust device cannot move to a new position after the travel. But, from the viewpoint of an outside observer who does not see inside the linear tube housing H, it appears that the housing has moved without expelling mass. The travel distance of this motion is limited. The masses A, B start out at opposite ends of the housing H and move toward each other. Mass A is decelerated by a one-way brake BR, which causes the internal masses A, B to end up at one end of the linear housing H.

With returning reference to FIGS. 1A, 1B, 1C and with further reference to FIG. 3B, in contrast, non-balanced-charging embodiments can enable larger travel distances. FIG. 3B shows a simplified diagram of the thrust device 10 of FIGS. 1A, 1B, 1C with the earth diagrammatically represented by a sphere. The thrust device 10 undergoes non-balanced charging in which mass is expelled. Non-balanced systems generate negative thrust during charging which is countered by an expelled much larger companion mass, such as the earth 16. When the thrust device 10 is charging, it pushes away the companion mass 16 during unbalanced charge-up. The low-mass vehicle housing does take a very small, generally imperceptible, step backwards. Momentum p=m×v is conserved because the earth has large mass m and low velocity v, while the inner masses 14 hidden within the housing 12 have low mass (relative to the earth) and high velocity. The inner masses 14 expel the companion mass of the earth 16. At a later time, that is, during the thrust sub-cycle, the housing is powered by the residual momentum of the hidden inner masses 14. Newton's laws of action and reaction are effectively delayed in time in direct proportion to the length of the housing 12.

The giant half-cycle inertial propulsion (GHC-IP) system hides the expulsion of propellant mass from view and delays the movement of the vehicle or other driven mass to a time in the future when it appears that the housing moves on its own. In a typical embodiment, the thrust device 10 may be 10,000 kilograms, and may charge-up overnight, sitting on the earth 16, which has a mass of about 6×10²⁴ kilograms. During the charging sub-cycle, the thrust device 10 appears to weight more than its rest mass, because the inner masses 14 are pushing the earth 16 down, along with the vehicle housing 12 attached to the earth. This tiny “backwards” movement is in accordance with Newton's laws of motion. The GHC-IP braking process or thrust sub-cycle is applied and the deceleration of the inner masses 14 lifts the housing 14 off of the earth 16. Note that the earth continues to move down and away from the thrust device 10, while the inner masses 14 continue to move up and away, but with a higher velocity (more displacement over the same time), since the mass of the housing 12 is so much smaller then the mass of the earth 16.

When viewed as a whole as shown in FIG. 3B, the earth and thrust device 10 collectively correspond to the total system shown in FIG. 3A. That is, the center of mass C of the earth 16/thrust device 10 system never moves in space. They simply separated for a time. Under the influence of gravity, the thrust device 10 returns to the earth 16 with the center of mass C unchanged. It only appears that the thrust device 10 lifted off from the earth 16 without expelling propellant.

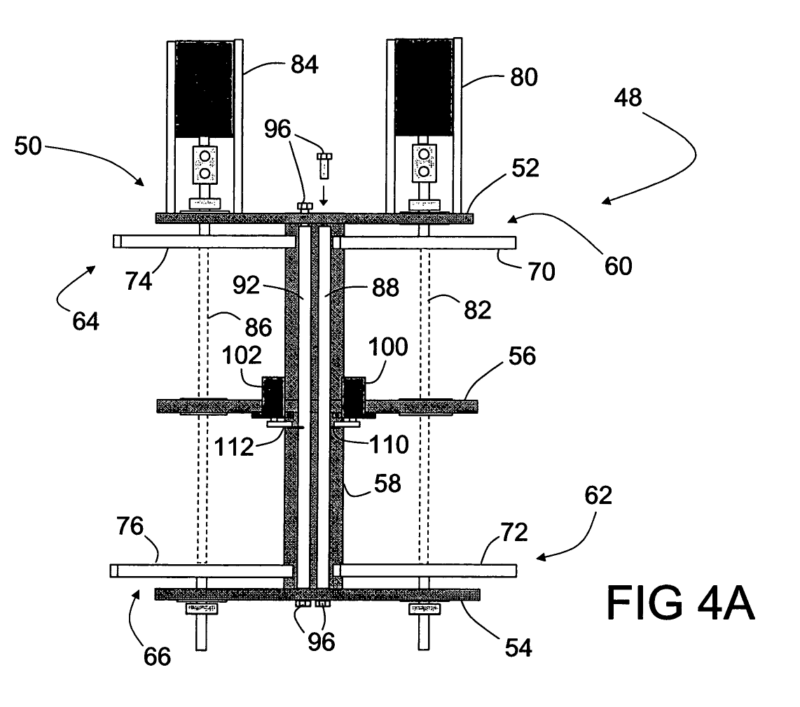

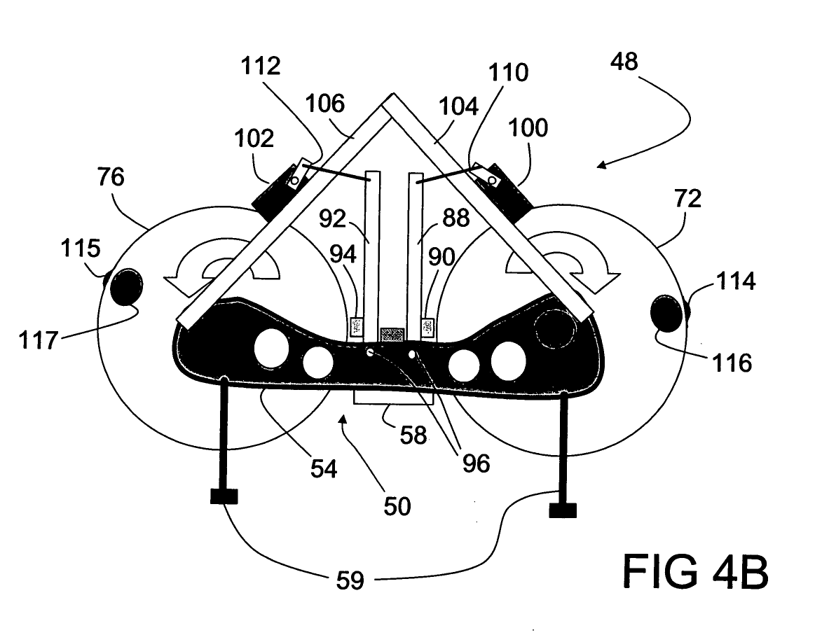

With reference to FIGS. 4A and 4B, a macroscopic thrust device 48 includes a frame 50 defined by three bulkheads 52, 54, 56 secured together by a welded crossbar 58 and supported by legs 59. Four inertiatrons 60, 62, 64, 66 include rotating wheels 70, 72, 74, 76 that define or support inner masses of the corresponding inertiatrons 60, 62, 64, 66. The inner mass rotating wheels 70, 74 are mounted to the outer bulkhead 52. The inner mass rotating wheels 72, 76 are mounted to the outer bulkhead 54. Although four inertiatrons 60, 62, 64, 66 include rotating wheels 70, 72, 74, 76 are illustrated, the frame 50 can accommodate additional inertiatrons. In one contemplated embodiment, for example, forty inertiatrons are included.

A drive motor 80 coupled to a driveshaft 82 provides acceleration for the inner mass rotating wheels 70, 72, while a drive motor 84 coupled to a driveshaft 86 provides acceleration for the inner mass rotating wheels 74, 76. Alternatively, a single drive motor can drive both drive shafts 82, 86 by coupling pulleys, chains, or the like. In the side view of FIG. 4B, the wheels 70, 72 are accelerated clockwise, while the wheels 74, 76 are accelerated counter-clockwise.

The four inertiatrons 60, 62, 64, 66 are decelerated using a brake system that includes a brake bar 88 and brake pad 90 that decelerates the wheels 70, 72 and a brake bar 92 and brake pad 94 that decelerates the wheels 74, 76. The brake bars 88, 92 are pivotally secured to the frame 50 by fasteners such as bolts or bolt-and-nut combinations 96. Servomotors 100, 102 mounted on inclined supports 104, 106 secured to the frame 50 drive shafts 110, 112 to tilt the brake bars 88, 92, respectively, about the fasteners 96 to engage and disengage the brake pads 90, 94 to effect controlled deceleration of the inner mass rotating wheels 70, 72, 74, 76. The brake pads 90, 94 engage raised portions 114, 115 of the wheels 70, 72, 74, 76 that are substantially aligned with inner masses 116, 117 disposed on the wheels 70, 72, 74, 76. The inner masses 116, 117 can be higher-density portions of the wheels 70, 72, 74, 76, masses secured to the wheels 70, 72, 74, 76, or the like.

The thrust device 48 operates as follows. During the charging sub-cycle or first giant half-cycle the drive motors 80, 84 accelerate the inner mass rotating wheels 70, 72, 74, 76 to a high rotational velocity. The accelerating of the inner masses 116, 117 produces a counter force that is transferred to the frame 50 through the legs 59 to the ground. When the drive motors 80, 84 are shut off and/or disconnected from the drive shafts 82, 86, the rotating wheels 70, 72, 74, 76 rotate freely. No net force is exerted on the frame 50 during this free rotation.

The thrust sub-cycle or second giant half-cycle is initiated by activating the brake system by moving the brake pads 90, 94 via the servomotors 100, 102 so that the brake pads 90, 94 frictionally brush against the raised portions 114, 115 of the wheels. Each time one of the raised portions 114, 115 brushes against the corresponding brake pad 90, 94, the brake pad exerts a decelerating force on the inner mass 116, 117 and experiences a corresponding counterforce directed “upward,” that is, away from the ground on which the legs 59 rest. This upward force is transferred through the corresponding brake bar 88, 92 to fastener 96 and thence to the frame 50, producing a net upward force on thrust device 48. The upward thrust can be maintained until the inner mass rotating wheels 70, 72, 74, 76 decelerate substantially to a stop. The braking force can be controlled by using the servomotors 100, 102 to vary the amount of braking force applied during each pass of the inner masses 116, 117.

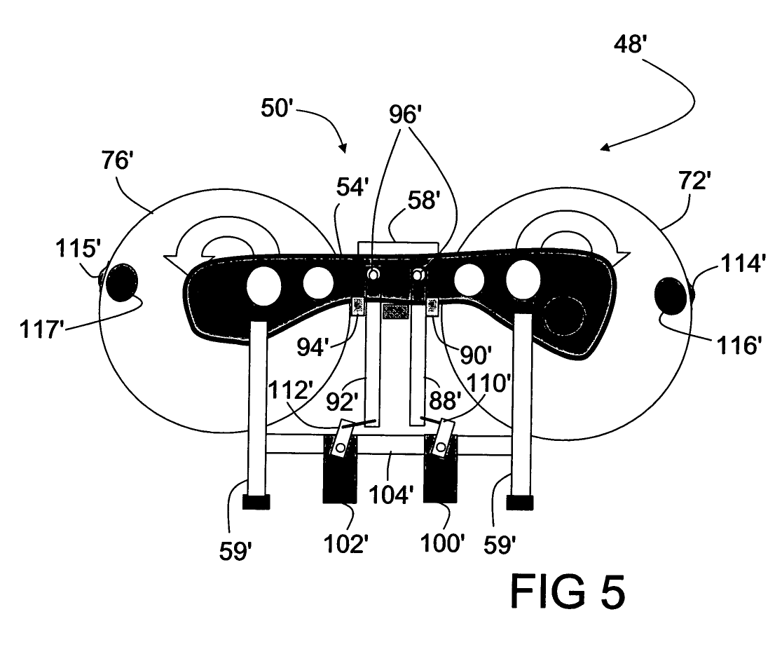

With reference to FIG. 5, a thrust device 48′ is similar to the thrust device 48. In FIG. 5, components of the thrust device 48′ corresponding to components of the thrust device 48 are labeled with corresponding primed numbers. Thus, inner mass wheels 72′, 76′ are secured to bulkhead 54′ of frame 50′ which is in turn welded or otherwise connected with cross bar 58′ and supported on the ground by legs 59′. The brake system of the thrust device 48′ is disposed underneath the frame 50′, and includes a brake bar 88′ and brake pad 90′ engaging a raised portion 114′ of the wheel 72′ and decelerating an inner mass 116′ disposed on the wheel 72′, and a brake bar 92′ and brake pad 94′ engaging a raised portion 115′ of the wheel 76′ and decelerating an inner mass 117′ disposed on the inner mass wheel 76′. The brake bars 88′, 92′ are pivotally secured to the frame 50′ by fasteners 96′. Servomotors 100′, 102′ are disposed on a common support 104′ disposed underneath the frame 50′. The thrust device 48′ of FIG. 5 operates substantially similarly to the operation of the thrust device 48.

For spinning wheel embodiments such as are described in FIGS. 4A, 4B, and 5, balanced charging is suitably obtained by indexing several wheels on a single shaft such that a shaft full of wheels (as a whole) is balanced. This allows for the use of a smaller motor, and less vibration during the spin-up of the wheels (that is, during the charging sub-cycle).

The time-averaged force F₁ provided by an inertiatron is given by:

F₁=N_{z}·Mₚ·dv/dt (1),

where: N_{Z} is the number of inner masses in the deceleration zone, that is, the average number of inner masses being decelerated; Mₚ is the mass of the inner masses; and dv/dt is the average reduction in velocity per unit time of the inner masses in the deceleration zone. For a single inner mass, N_{Z} is less than unity, since the single inner mass is only in the deceleration zone for a portion of the closed loop trajectory. Throttling is achieved by varying the deceleration force corresponding to dv/dt.

A single inertiatron having a single inner mass provides a jerky or pulsating thrust force each time the inner mass passes through the deceleration zone. In contrast, using a beam of particles to provide a large number of inner masses provides a more uniform thrust force. For a large number of particles, the number N_{Z} of particles in the deceleration zone is substantially constant as a function of time.

Additional thrust force and uniformity of thrust force can be achieved by combining or ganging together a plurality of inertiatrons. In this case, the thrust force Fₜₕ is given by:

Fₜₕ=F₁·N₁·Pₒₚ (2),

where N₁ is the total number of inertiatrons working in parallel and Pₒₚ is the fraction of inertiatrons operating to provide thrust. If all the inertiatrons are actively providing thrust, Pₒₚ equals unity. If the deceleration dv/dt is constant, then the total thrust output time T is given by:

T=Vᵢ/(dv/dt) (3),

where Vᵢ is the initial velocity of the inner masses. Thus, it is seen that to provide a long thrust time with substantially uniform thrust over that time a large number of inner masses should be accelerated to high initial velocities during the charging sub-cycle or first giant half-cycle of the thrust device.

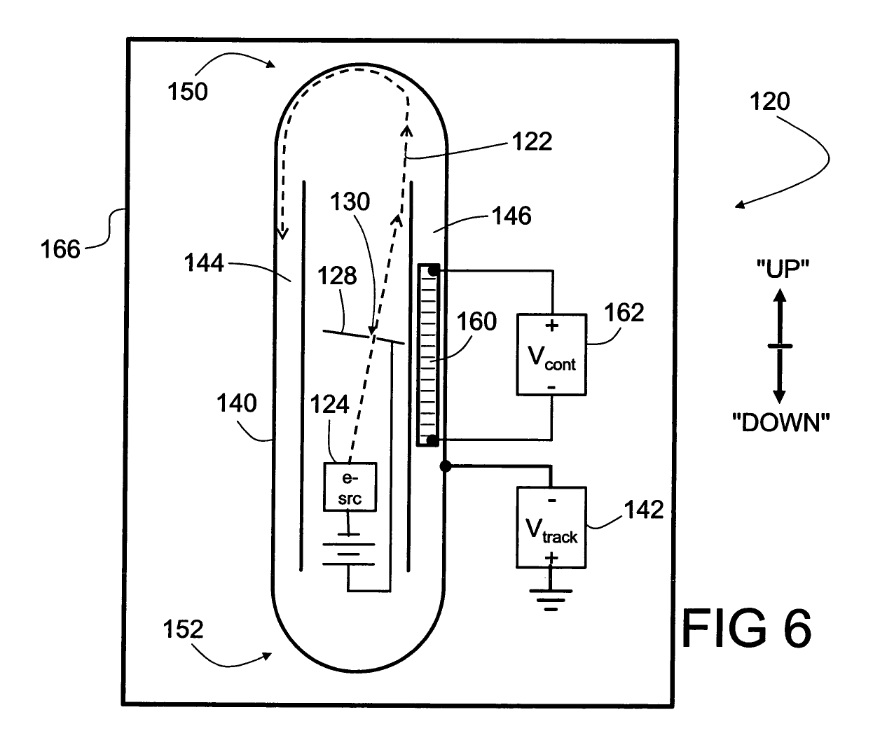

With reference to FIG. 6, an inertiatron 120 operates using an electron beam 122 as the inner masses. The electron beam 122 is produced by an electron source 124 such as a heated filament, a field emission electron source, or the like, and a focusing biasing grid 128 that collimates and accelerates the sourced electrons through a grid aperture 130 to define the electron beam 122. A track 140 is biased positively relative to electrical ground or common by a track biasing source 142. The positively biased track 140 includes conduits 144, 146 through which the electrons of the electron beam 122 pass substantially centered due to the influence of the positive track bias.

At each end 150, 152 of the track 140, the positive bias deflects, rebounds, or reflects the electron beam to turn it 180°. While a single track biasing source 142 is shown, it is also contemplated to employ larger biasing at the ends 150, 152, to provide a stronger beam turning force. The track 140 and biasing 142 is exemplary only. Suitable electrostatic fields for keeping the electron beam 122 confined, and biasing for creating such fields, are readily computed using Maxwell equations-based electromagnetic computations, determined using finite element electromagnetic simulations, or the like. Moreover, magnetic fields can be used instead of or in addition to electrostatic fields to define the closed loop trajectory of the electron beam 122.

An accelerator/decelerator grid 160 is disposed in the conduit 146 and is biased by a control bias source 162. When the control bias 162 has the polarity shown in FIG. 6, the effect is to accelerate the electrons of the electron beam 122 each time the electrons pass through the acceleration zone defined by the grid 160. Alternatively, if the control bias 162 is reversed in polarity, the grid 160 acts as a deceleration grid that decelerates or brakes the electrons of the electron beam 122 each time the electrons pass through the deceleration zone defined by the grid 160. The bias in this case defines the term dv/dt in Equations (1) and (3).

The accelerator/decelerator grid 160 is secured to a substrate 166. In one embodiment, the electron source 124, focusing grid 128, track 140, biasing sources 142, 162 (or circuitry communicating the biases from one or more external voltage sources), and grid 160 are fabricated on the substrate 166 using lithographic techniques. Rather than using a single grid 160 for both acceleration and deceleration, it is contemplated to provide separate acceleration and deceleration grids. For example, a separate acceleration grid can be disposed in the conduit 144. Moreover, it is contemplated to employ a continuous grid substantially coextensive with the track 140, with acceleration/deceleration biasing ports arranged along the track 140. By applying decelerating biases along selected portions of the track 140, the direction of thrust force produced by the inertiatron 120 is electronically selectable.

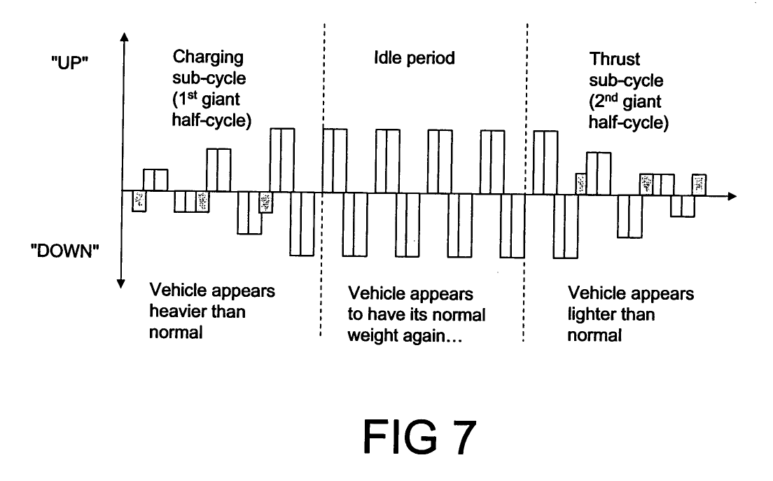

With continuing reference to FIG. 6 and with further reference to FIG. 7, the forces exerted on the substrate 166 by an electron of the electron beam 122 are plotted. Reference directions “up” and “down” are indicated in FIG. 6. For a thrust device producing thrust in opposition to earth's gravitational force, the reference “up” and “down” directions correspond to their ordinary terrestrial meaning. However, it will be appreciated that the forces are exerted regardless of the frame of reference in which the inertiatron 120 is disposed. Thus, reference directions “up” and “down” are intended as generic reference directions.

FIG. 7 plots a giant cycle including a charge sub-cycle or first giant half-cycle, an idle period, and a thrust sub-cycle or second giant half-cycle. There are two types of forces plotted: “rebound” forces exerted by the electron on the ends 150, 152 of the track 140 and thence to the substrate 166; and accelerator/decelerator counter-forces exerted on the grid 160 and thence to the substrate 166. For elastic rebounding, the rebound forces at end 150 and the rebound forces at end 152 cancel; these canceling forces are indicated by unfilled bars in FIG. 7. The accelerator/decelerator counter-forces are the operative forces and are indicated by filled bars.

During the charge sub-cycle or first giant half-cycle, the control bias 162 is as shown in FIG. 6, and the electron is gradually accelerated. Each acceleration event produces a downwardly directed accelerator counterforce exerted on the substrate 166. If the substrate 166 is secured to the ground or another massive companion mass, these accelerator counterforces are absorbed and do not produce motion of the inertiatron 120. Rather, the effect of these accelerator counterforces is to make the inertiatron 120 appear to be heavier than usual. Additionally, as the electron accelerates the rebounding forces increase. However, the rebound at each end 150, 152 continues to substantially cancel as the rebound forces' magnitude increases.

When the electron is accelerated to a desired velocity, the control bias 162 is turned off, and the inertiatron enters the idle period. There are no accelerator/decelerator counterforces, and the rebound forces continue to cancel. During the idle period, the inertiatron 120 appears to be at its usual weight.

During the thrust sub-cycle or second giant half-cycle, the control bias 162 has a polarity opposite to that shown in FIG. 6, and the electron is gradually decelerated. Each deceleration event produces an upwardly directed decelerator counterforce exerted on the substrate 166. These decelerator counterforces make the inertiatron 120 appear to be lighter than usual. For a beam of electrons in which the decelerator counterforces of all the inertiatrons add in accordance with Equation (1), the total counterforce may be sufficient to overcome the force of gravity and cause the inertiatron 120 to lift off the ground. Additionally, as the electron decelerates the rebounding forces decrease. However, the rebound at each end 150, 152 continues to substantially cancel as the rebound forces' magnitude increases. Eventually, the electron slows down to a standstill. If the control bias 162 is left on beyond that point, the electron begins to accelerate in the opposite direction. In one embodiment, the decelerating bias on the grid 160 is pulsed during deceleration to reduce bunching of electrons of the electron beam 122 during the thrust sub-cycle.

In FIG. 6, a single grid 160 embodies both the accelerator and the decelerator. It is also contemplated, however, to provide separate accelerator and decelerator grids. For example, the inertiatron 120 could be modified by disposing an accelerator grid in the conduit 144 to produce an inertiatron that functions as the inertiatron 46′ of FIG. 3. In this embodiment, the accelerator grid disposed in the conduit 144 corresponds to the accelerator 40′ of the inertiatron 46′.

The inertiatron 120 of FIG. 6 obtains increased and more uniform thrust through the use of a large number of inner masses corresponding to the electron beam 122. However, the intensity of the electron beam 122 is limited by the electron-generating capacity of the electron source 124 and by the current-carrying capacity of the track 140. For example, as the density of electrons in the beam increases, electron-electron interactions become significant and may adversely affect performance. It will be appreciated, however, that a relatively small current corresponds to a very large number of electrons. Each ampere of current corresponds to about 6×10¹⁸ electrons entering the deceleration region each second. Thus, one trillion electrons (that is, 10¹² electrons) correspond to a current of 0.167 microamperes of current.

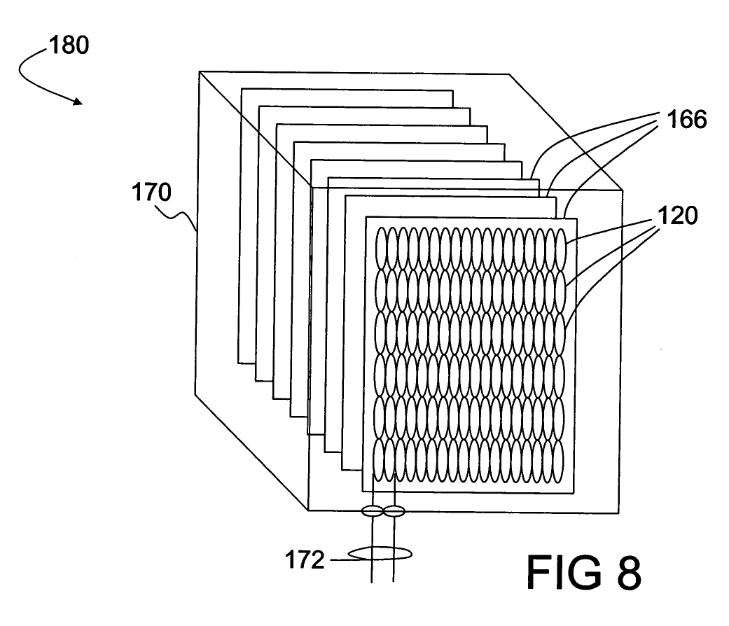

With reference to FIG. 8, a large number of inertiatrons 120 are formed on a plurality of substrates 166. In one embodiment, the inertiatrons 120 are fabricated using standard printed circuit board and photolithography techniques to create thin sheets or pages of inertiatrons on substrate sheets 166. Each substrate sheet 166 suitably contains millions or billions of fabricated inertiatrons 120. The substrate sheets 166 are bonded together, and are bonded to and hermetically sealed in an evacuated vacuum-tight outer container 170. Electrical leads 172 provide electrical power input to the inertiatrons 120. In one contemplated embodiment, each inertiatron 120 is about 0.05×0.01 cm in area, and each substrate sheet 166 is about 0.01 cm thick and contains a 400×2500 array of inertiatrons 120. One thousand such substrate sheets 166 correspond to a “book” 10 cm thick that contains one billion inertiatrons. For such a “book” in which each inertiatron 120 has about 1×10²⁰ electrons passing through the deceleration zone at any given time with a single-pass deceleration of about 80,000 n/sec², a total thrust of about 36.8N spanning a thrust time of about 125 seconds is achievable. Total thrust for a vehicle is readily scaled up by including additional “books” of inertiatrons. Similarly, thrust time can be scaled up by including a plurality of books and staggering the thrust sub-cycle discharge of the books over time. Of course, these are example dimensions, and other dimensions can be used.

With continuing reference to FIG. 8, a unit 180 includes the plurality of inertiatrons 120 secured to the common housing or container 170 and cooperatively providing thrust. Such a unit including a plurality of cooperating inertiatrons is referred to as an inertiatron device herein, to distinguish from a single inertiatron such as the inertiatron 120 shown in FIG. 6. Thus, the inertiatron device 180 is one example of an inertiatron device. It will be appreciated, however, that in a commercial setting a consumer or user will generally see the inertiatron device 180 as a box or other housing with an electrical cable extending therefrom. The consumer or user will generally not see individual inertiatrons such as the inertiatron 120 of FIG. 6, since these individual devices will generally be enclosed and/or microscopic. It is thus expected that the term “inertiatron” may also be used in the art to refer to an inertiatron device, such as the inertiatron device 180 of FIG. 8.

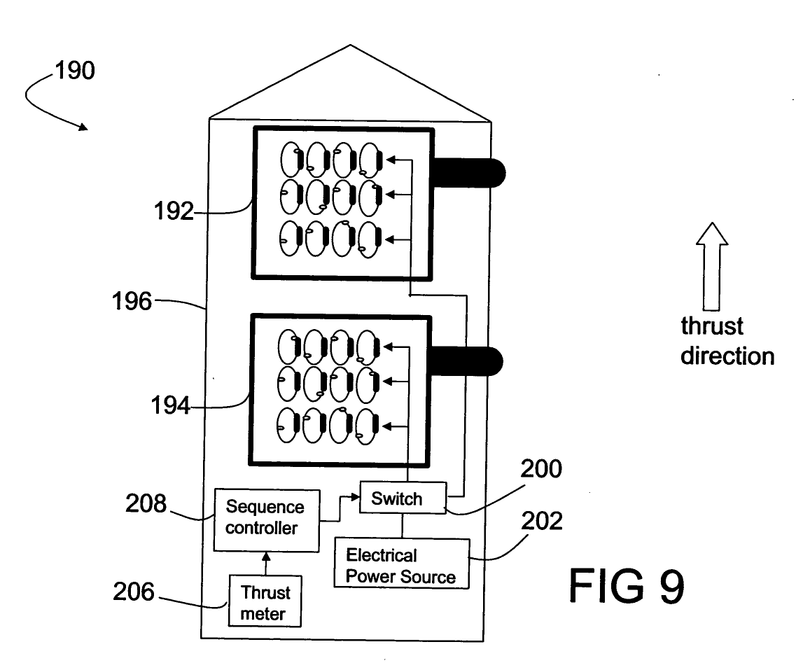

With reference to FIG. 9, a thrust device 190 includes two inertiatron devices 192, 194 secured to a common housing 196. The inertiatron devices 192, 194 are operated in a manner in which one inertiatron device provides thrust while the other inertiatron device is recharging. For example, the inertiatron devices 192, 194 can each contain a plurality of inertiatrons 120 (one example inertiatron 120 is shown in FIG. 6). Initially the inertiatron device 192 can be connected by a switch 200 to an electrical power source 202 to provide a decelerating voltage across the biasing grids 160 of the inertiatrons 120 of the inertiatron device 192. Thus, the inertiatron device 192 is operating in thrust mode. (This assumes that the inertiatron device 192 was initially charged). At the same time, the inertiatron device 194 is connected by the switch 200 to the electrical power source 202 to provide accelerating voltage across the biasing grids 160 of the inertiatrons 120 of the inertiatron device 194.

The electrons of the electron beams 122 of the inertiatrons 120 of the inertiatron device 192 slow down over time due to the intermittent deceleration. Eventually, the slowed electrons cause a reduction in thrust that is detected by a thrust meter 206. For example, the thrust meter 206 may measure force applied to the housing 196, velocity of the housing 196, altitude measured by an altimeter in the case of a constant altitude lift application, or another parameter related to the applied thrust.

A sequence controller 208 reads the thrust meter and, responsive to a detected reduction in thrust, operates the switch 200 to swap operation of the inertiatron devices 192, 194. The inertiatron device 194 is switched into the thrust sub-cycle by reversing the bias polarity on the grids 160 of the inertiatrons 120 of the inertiatron device 194 to apply deceleration, while the inertiatron device 192 is switched into the charging sub-cycle by reversing the bias polarity on the grids 160 of the inertiatrons 120 of the inertiatron device 192 to apply acceleration to the electrons.

To avoid the charging inertiatron device applying a net negative force that opposes the thrust, the forces exerted on the inner masses of the inertiatrons are preferably substantially synchronously balanced during the charging sub-cycle. For example, the arrangement of inertiatrons shown in FIG. 3 can be employed to produce a net cancellation of acceleration counterforces.

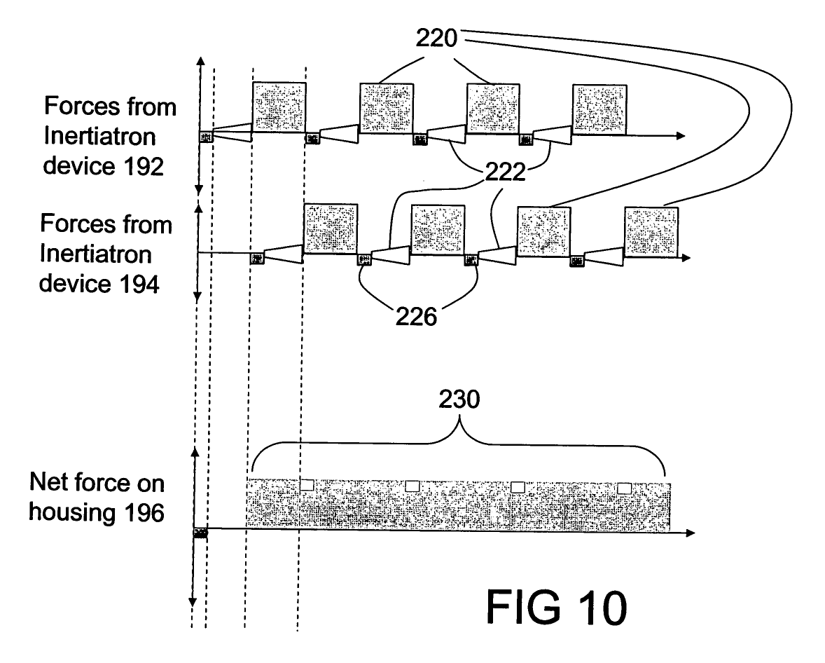

With reference to FIG. 10, the forces on the housing 196 produced by the inertiatron devices 192, 194 are plotted. In FIG. 10, synchronously balanced acceleration configurations of the inertiatron devices 192, 194 are assumed. The thrust sub-cycles 220 of the inertiatron device 192 overlap the charging sub-cycles 222 of the inertiatron device 194, and vice versa. Each charging sub-cycle 222 is substantially force-balanced, and may produce some pulsating forces but substantially zero average thrust. Each charging sub-cycle 222 is preceded by a short rebalance interval 226 during which the inner masses are rebalanced using a small amount of energy. The remainder of the charging sub-cycle 222 is substantially force balanced. The net force 230 is dominated by the thrust sub-cycles 220 and may include non-uniformities but preferably does not include periods of negative thrust.

The arrangement described with reference to FIGS. 9 and 10, in which one of two inertiatron devices provides thrust while the other is charging and in which the thrust and charge cycles alternate, is also referred to herein as “ping-ponging” of the inertiatron devices. It will be appreciated that more than two inertiatron devices can be sequenced in a ping-pong relationship. Moreover, because the ping-ponged inertiatron devices are charged using balanced charging to substantially reduce negative forces, the travel distance is limited by conservation of momentum as described with reference to FIGS. 3 and 3A.

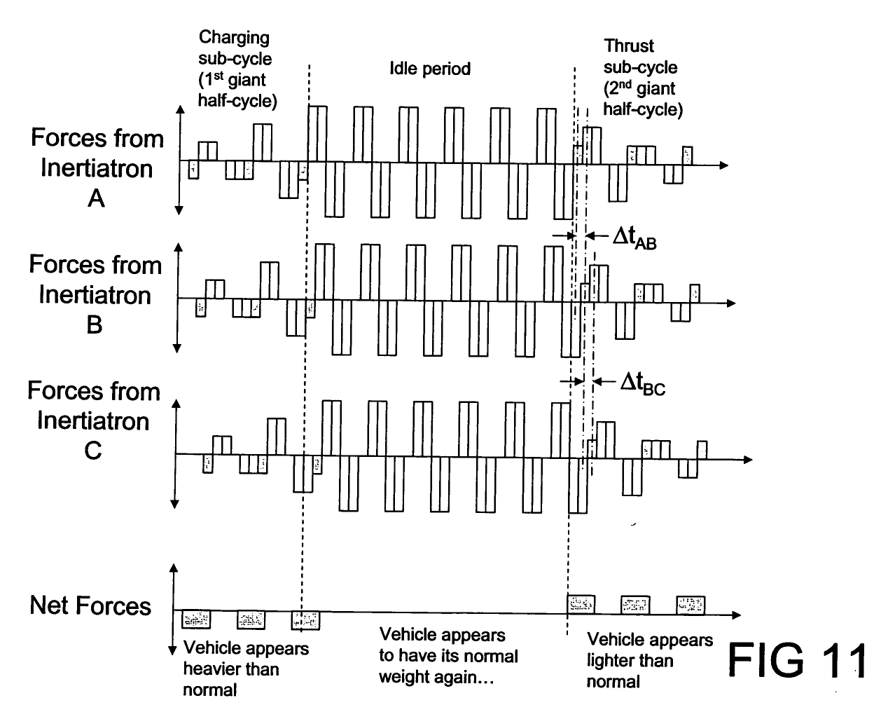

With reference to FIG. 11, an approach for reducing thrust force pulsations during the pulse cycle is described. FIG. 11 plots the counterforces produced by three inertiatrons identified as “inertiatron A”, “inertiatron B”, and “inertiatron C”. FIG. 11 uses the same notation as FIG. 7, in which the “rebound” forces that substantially cancel are shown as unfilled bars, and the accelerator/decelerator counter-forces that generally do not cancel are shown as filled bars. Only a single inner mass is used for each of the inertiatrons “A”, “B”, and “C”. The inner mass of inertiatron “B” traverses its trajectory at a time lagging that of inertiatron “A” by a time Δt_{AB}. Similarly, the inner mass of inertiatron “C” traverses its trajectory at a time lagging that of inertiatron “B” by a time Δt_{BC}. The time intervals Δt_{AB} and Δt_{BC} are selected such that the accelerator/decelerator counterforces of the three inertiatrons do not overlap in time. This produces a smoother, less pulsating net force (net accelerator/decelerator forces are plotted at the bottom of FIG. 11). In one embodiment, the time intervals Δt_{AB} and Δt_{BC} are selected such that the cycling of the three inertiatrons “A”, “B”, and “C” are phased by 120° analogous to three-phase electrical power. Moreover, additional inertiatrons can be similarly phased in time to substantially avoid overlapping of the accelerator/decelerator counterforces.

For larger numbers of inertiatrons, such as in the inertiatron devices of FIGS. 8 and 9, the forces produced by individual inertiatrons average over time to provide substantially uniform thrust. Hence, the phased arrangement of FIG. 11 is typically most useful when a small number of inertiatrons are operating collectively.

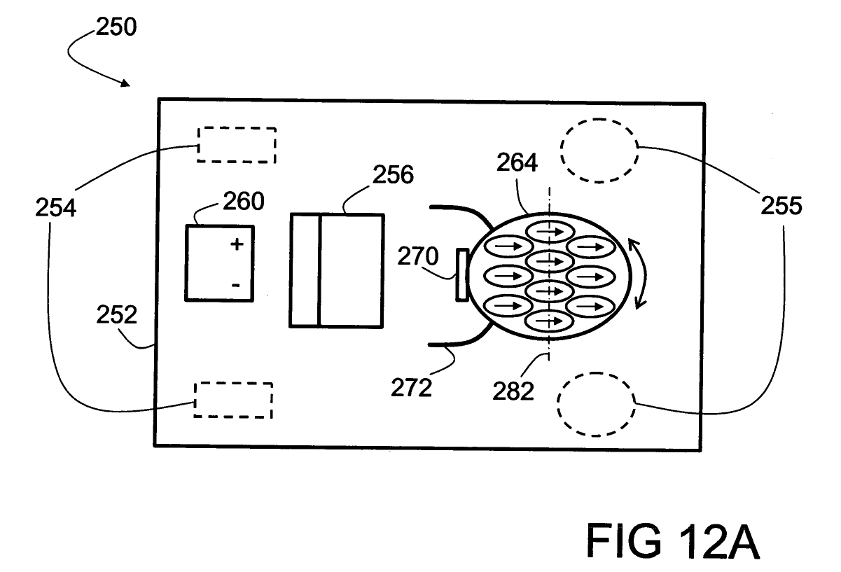

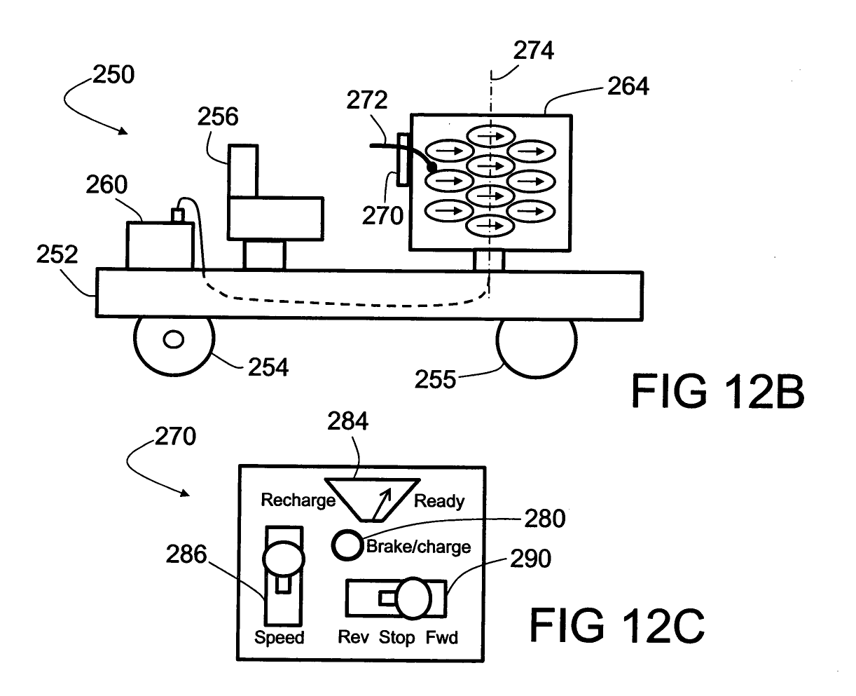

With reference to FIGS. 12A, 12B, and 12C, a vehicle 250, such as a golf cart, farm tractor, or the like, includes a platform, chassis, or vehicle frame 252 arranged to roll on two fixed rear wheels 254 and two front pivot-mounted wheels or casters 255. The vehicle frame 252 supports a seat 256 for an associated operator or driver, and also supports an electric battery 260.

The vehicle 250 is propelled by an inertiatron device 264. In FIGS. 12A and 12B, inertiatrons contained in the inertiatron device 264 are diagrammatically represented by an oval representative of the inertiatron inner mass path or trajectory and an arrow indicating the direction of thrust force during the thrust sub-cycle. The number of inertiatrons shown in FIGS. 12A and 12B is also diagrammatic; in some contemplated devices, the number of inertiatrons actually contained in the inertiatron device 264 is contemplated to number in the millions or billions. The inertiatron device 264 receives electrical power from the battery 260 to charge the inner masses to an operating velocity during the charge sub-cycle and to power decelerators or brakes that are operative during the thrust sub-cycle.

The associated operator or driver seated in the seat 256 controls the vehicle 250 using a control panel 270 and steering handles 272. The operator uses the handles 272 to rotate the inertiatron device 264 about an axis 274 generally transverse to the platform 252. By turning the inertiatron device 264 about the axis 274, the thrust force can be deviated left and right to effect left and right turns of the vehicle 250. The front pivot-mounted wheels or casters 255 accommodate the turning.

With particular reference to FIG. 12C, during the charge sub-cycle, the operator or driver preferably activates a vehicle brake using brake/charge button 280 that locks at least some of the wheels 254, 255 to prevent the vehicle 250 from moving under the influence of counterforces exerted by the inertiatron device 264 during the charging sub-cycle. Alternatively or in addition, the inertiatron device 264 can be substantially synchronously balanced so that the net force exerted during the charging sub-cycle is substantially zero. As yet another option, the inertiatron device 264 can be pivoted about a second axis 282 so that the counterforces exerted by the inertiatron device 264 during the charging sub-cycle are directed downward toward the ground.

A meter 284 monitors the charge of the inertiatron device 264. This monitoring can be done indirectly, for example by measuring the amount of energy (E=IVT where I=current, V=voltage, and T=time) input into the inertiatron device 264 by the battery 260. Alternatively, the charge of the inertiatron device 264 can be measured more directly, for example by measuring a magnetic field produced by the cycling electron beams of the inertiatrons.

The operator or driver also has access to a throttle control 286 that adjusts the decelerator force of the inertiatrons contained in the inertiatron device 264. In accordance with Equations (1) and (2), the throttle 286 adjusts the deceleration force corresponding to dv/dt applied to the inner masses and hence adjusts the thrust force. In another embodiment in which the inertiatron device 264 corresponds to the inertiatron device 180 of FIG. 8, the throttle 286 may adjust the number of substrate sheets 166 which have their inertiatron decelerators activated, thus controlling thrust force by controlling the number of inertiatrons in the thrust sub-cycle.

Optionally, the operator or driver has a forward/reverse/stop switch 290. This switch can select between forward thrust, reverse thrust, or no thrust. The no thrust setting suitably corresponds to de-energizing the decelerator of the inertiatrons so that no net thrust force is produced. It is contemplated for the reverse setting to correspond to placing the inertiatron device 264 into the charge sub-cycle and employing the counterforces produced during acceleration of the inner masses to provide reverse thrust. It will be appreciated that since reverse operation is typically used intermittently, for example to back out of a corner, a limited reverse thrust is generally sufficient.

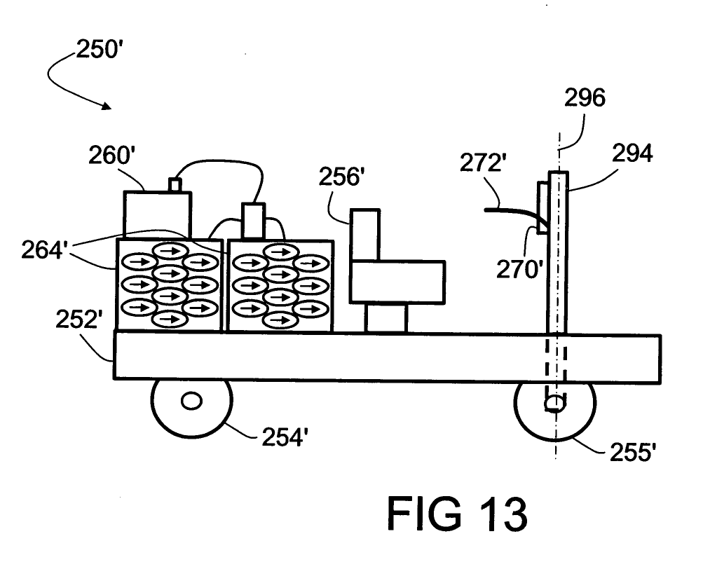

With reference to FIG. 13, a vehicle 250′ is similar to the vehicle 250. In FIG. 13, components of the vehicle 250′ corresponding to components of the vehicle 250 are labeled with corresponding primed numbers. Thus, frame 252′ rolls on fixed rear wheels 254′ and one or more pivotable front wheels 255′, and supports a seat 256′, an electric battery 260′, two inertiatrons 264′, control panel 270′, and steering handles 272′. Unlike the vehicle 250, the vehicle 250′ has the inertiatron devices 264′ mounted in fixed rather than rotatable fashion, and the inertiatron devices 264′ are located near the rear of the vehicle 250′ near the battery 260′. Thus, the inertiatron devices 264′ cannot be rotated to deflect the thrust force.

Rather, the vehicle 250′ has a steering column or shaft 294 rotatable about an axis 296. The steering column or shaft 294 is coupled to the pivotable front wheel or wheels 255′ such that rotation of the pivotable front wheel or wheels 255′ by the operator or driver causes the pivotable front wheel or wheels 255′ to rotate or pivot correspondingly to provide steering. The control panel 270′ and the steering handles 272′ are mounted on the steering column or shaft 294 so that the steering column or shaft 294 can be rotated about the axis 296 by moving the steering handles 272′.

In one embodiment, two inertiatron devices 264′ are provided, as shown in FIG. 13. The inertiatron devices 264′ can be ping-ponged as described with reference to FIGS. 9 and 10 to provide continuous thrust as long as the electric battery 260′ is charged.

The vehicles 250, 250′ are exemplary only. Those skilled in the art can readily construct other land vehicles that employ inertiatrons to provide thrust. Advantageously, the distribution of thrust amongst millions or billions of inertiatrons of the inertiatron device limits the likelihood of catastrophic loss of vehicle propulsive thrust force. For example, considering the inertiatron device 180 shown in FIG. 8, most failure modes will involve failure of a single inertiatron 120 or the failure of the inertiatrons 120 on one of the substrate sheets 166. Such a failure will result in an incremental loss in thrust force, but will not result in complete, catastrophic loss of propulsive thrust force.

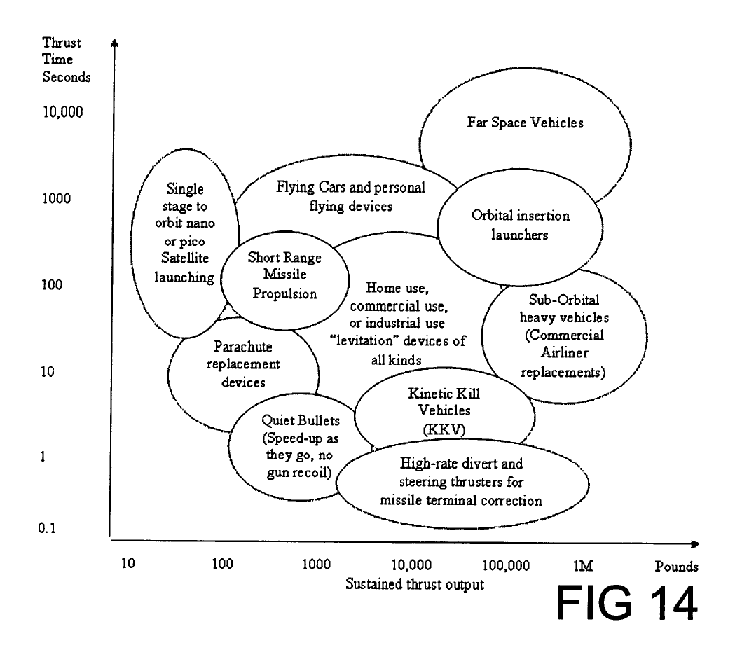

With reference to FIG. 14, it is contemplated to use one or more inertiatron devices to provide thrust force in a substantially any type of land, water, air, or space vehicle, including for example missiles, commercial airliners, sub-orbital heavy vehicles, orbital insertion launchers, flying cars, motorcycles, boats, ships, submarines, and the like. For aircraft and some other vehicles, the inertiatron device or devices are preferably rotatably mounted or mounted on a gimbal mount to provide rotation about two axes. A gimbal mount may be used, for example, in implementing rotation of the inertiatron 264 of FIGS. 12A and 12B about transverse axes 274, 282. Rotational or gimbal mounting allows the direction of the thrust force to be readily controlled.

One issue that can arise with inertiatron devices employing inner masses following closed loop paths or trajectories is that the inertiatron device can develop a substantial moment of inertia. This moment of inertia can be advantageous, for example in the case of a motorcycle where the cycling inner masses can contribute, along with the rotating ground wheels, to the stability of the moving motorcycle. Moreover, if the inner masses are charged particles, magnetic fields produced by the cycling particles can be used to measure velocity of the inner masses and thus to determine the charge level of the inertiatron device.

For some applications, however, the developed moment of inertia can be disadvantageous. In such cases, the inertiatrons of the inertiatron device can be rotationally balanced, with about one-half of the inertiatrons having inner masses rotating “clockwise” and the other half of the inertiatrons having inner masses rotating “counter-clockwise” so that the net moment of inertia is substantially zero. For example, in the inertiatron device 170, such balancing is readily accomplished by flipping about one half of the substrate sheets 166 over along an axis parallel to the direction of the accelerator/decelerator grid forces. Alternatively, inertiatrons with inner masses rotating clockwise and inertiatrons with inner masses rotating counter-clockwise can be interspersed on a single substrate sheet 166. The clockwise-rotating and counter-clockwise-rotating inertiatrons should be arranged so that the decelerating or braking forces of the inertiatrons additively combine regardless of the direction of inner mass rotation. It will be appreciated that such arrangements of balanced clockwise and counter-clockwise rotating inertiatrons also advantageously balances out generated magnetic fields in devices employing electrically charged inner masses.

Moreover, inertiatron devices are readily employed in other devices. For example, a parachute equipped with an inertiatron device can provide an upward thrust force to counter gravity. Such a parachute does not depend upon air resistance; hence, the inertiatron device-based parachute is operable in vacuum. Moreover, since the thrust is positively generated rather than relying upon air resistance, steering of the inertiatron device-based parachute is readily achieved. Inertiatron devices can also be employed in elevators to replace complex pulley-based elevator lift systems. In addition to providing thrust, inertiatron devices can be employed as energy storage devices.

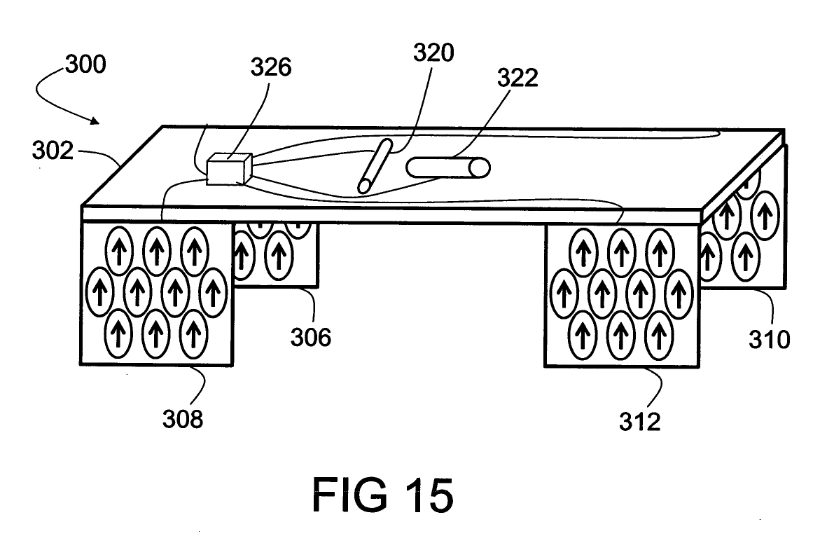

With reference to FIG. 15, a self-leveling levitation platform 300 includes a platform 302 and four inertiatron devices 306, 308, 310, 312 arranged at the four corners of the platform 302. Level-detecting devices 320, 322, such as mercury filled leveling devices, can be employed to detect tilting of the platform 302, and a microprocessor 326 receiving level data from the level-detecting devices 320, 322 suitably adjusts the upward thrust produced by each of the four inertiatron devices 306, 308, 310, 312 to maintain the platform 302 at a level position. Moreover, by throttling the total thrust produced by the four inertiatron devices 306, 308, 310, 312, the levitation platform 300 can be raised or lowered against gravity.

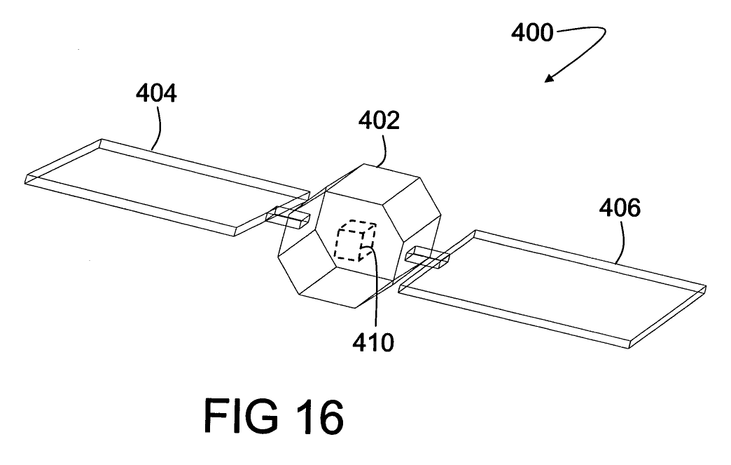

With reference to FIG. 16, a satellite 400 includes a main satellite housing 402. Solar panels 404, 406 extend away from the satellite housing 402 to convert solar energy into electricity by photovoltaic conversion or another power conversion process. An inertiatron device 410 disposed in the satellite housing 402, as shown (inertiatron 410 shown in phantom), or externally secured to the satellite housing, provides thrust force for steering the satellite 400. The inertiatron device 410 is preferably gimbal-mounted within the satellite housing 402 so that it can be rotated to provide thrust force in substantially any direction. Moreover, one or more inertiatron devices mounted asymmetrically with respect to a center of mass of the satellite 400 can provide thrust force directed toward rotating the satellite about one or more axes.

Other types of inertiatrons besides the illustrated macroscopic and electron beam-based inertiatrons are contemplated. For example, microelectromechanical systems (MEMS) technology can be used to produce mechanically based inertiatrons having inner masses accelerated by micro-motors and decelerated by microelectromechanical brake mechanisms. Such MEMS inertiatrons are readily fabricated by the hundreds, thousands, tens of thousands, or more on a single substrate of silicon or another material. Advantageously, such devices may operate in atmosphere, obviating the hermetic sealing used, for example, in the inertiatron device 180 of FIG. 8.

Moreover, the electron beam 122 of the inertiatron 120 can be replaced by a beam of protons. Advantageously, each proton is 1800 times more massive than an electron. In any inertiatron that uses charged particles as inner masses, there is the potential to accelerate the masses to relativistic speeds. Acceleration to relativistic speeds is advantageous for achieving thrust times of minutes to hours. However, lower non-relativistic speeds can also be employed, such as electrons accelerated into the 100 eV to 100 KeV range prior to switching over from the charging sub-cycle to the thrust sub-cycle. Temporally extended operation of such devices can be achieved by ping-ponging.

Rather than employing an electrically biased track that drives electrons around an evacuated pathway, such as is employed in the inertiatron 120, the track track defining the trajectory can be an electrically conductive solid material such as a semiconductor track, a metal track, or a track made of an electrically superconducting material.

Still further, it is contemplated to employ inertiatrons constructed as three-dimensional solid state or gas state devices using external electrostatic and/or electromagnetic fields to excite or accelerate the inner masses in cyclical motions within a confined volume. Thrust to weight ratio for such inertiatron devices can be advantageously high. Rebound structures or tracks are not employed in these embodiments because the atomic structure of the material itself provides the elasticity used to contain the oscillating inner masses.

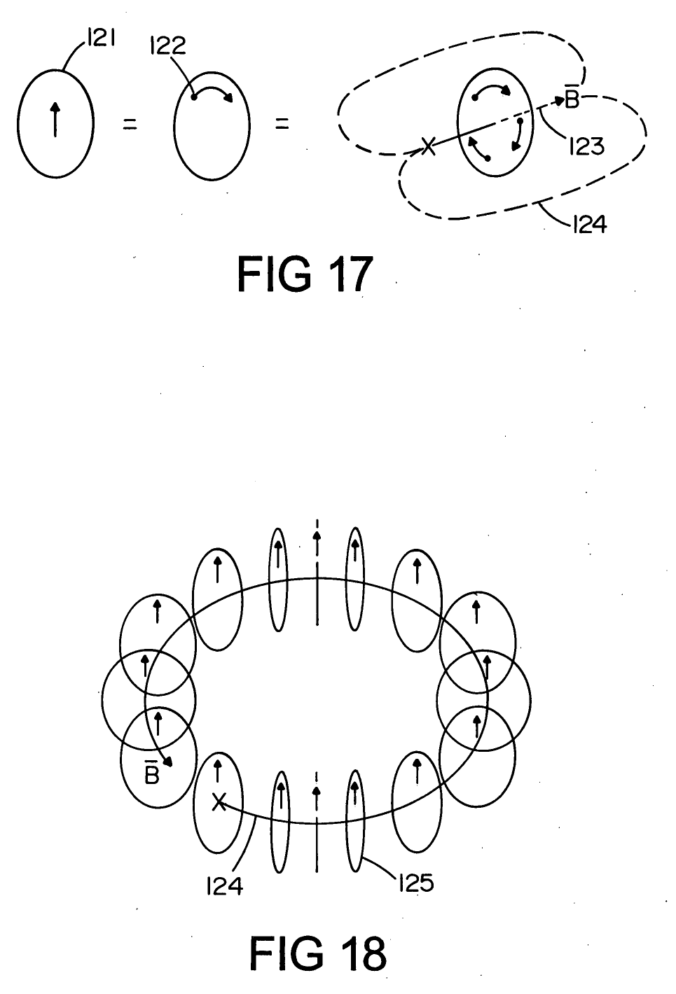

Referring now to FIG. 17, those trained in the science of electrodynamics will immediately recognize that when charged particles 122 are used as the rotating mass(es) in a single track inertiatron 121 that a magnetic field 123 is generated. This is due to the fact that the charged particle stream, spinning in a circular, or near circular motion path, creates a magnetic field vector, directed perpendicular to the plane of rotation of the charged particles. The magnetic field 123 commonly referred to in the art as a “B” field is a vector, with magnitude and direction. The direction of the magnetic field vector is well known in prior art and is given by Maxwell's equations and the “right-hand rule”. FIG. 17 shows the resultant magnetic field lines of Flux 124 wrapping around the outside of the single inertiatron track. When large numbers of charged-particle-type inertiatron tracks are ganged together in planer arrays such as decpicted in FIG. 8, the resultant magnetic field lines created by the inertiatrons are complex, and are not contained inside the device. This can cause electromagnetic interference to other electrical equipment and living things nearby. Furthermore, these field lines can actually serve to disturb the motion of neighboring inertiatron tracks since the motion path of any charged particle is affected by nearby magnetic fields.

Looking now at FIG. 18, those trained in magnetic field theory will understand that when a plurality of charged-particle-type inertiatrons 125 are arranged in a circle, the superposition of all resulting B fields 124 will not radiate outside the torroidal (donut) shape formed by the circle. The resulting magnetic field 124 generated by the summation of all track interactions is stronger then that of a single track and it stays confined within the interior of the torroid. Furthermore, and most advantageous of this exemplary torroidal shape, is that the confined magnetic field imparts a restraining force which acts opposite to the outward centripetal force on each particle, thus helping to keep the charged-particles moving in their circular trajectories so they do not crash into the wall of the torroid.

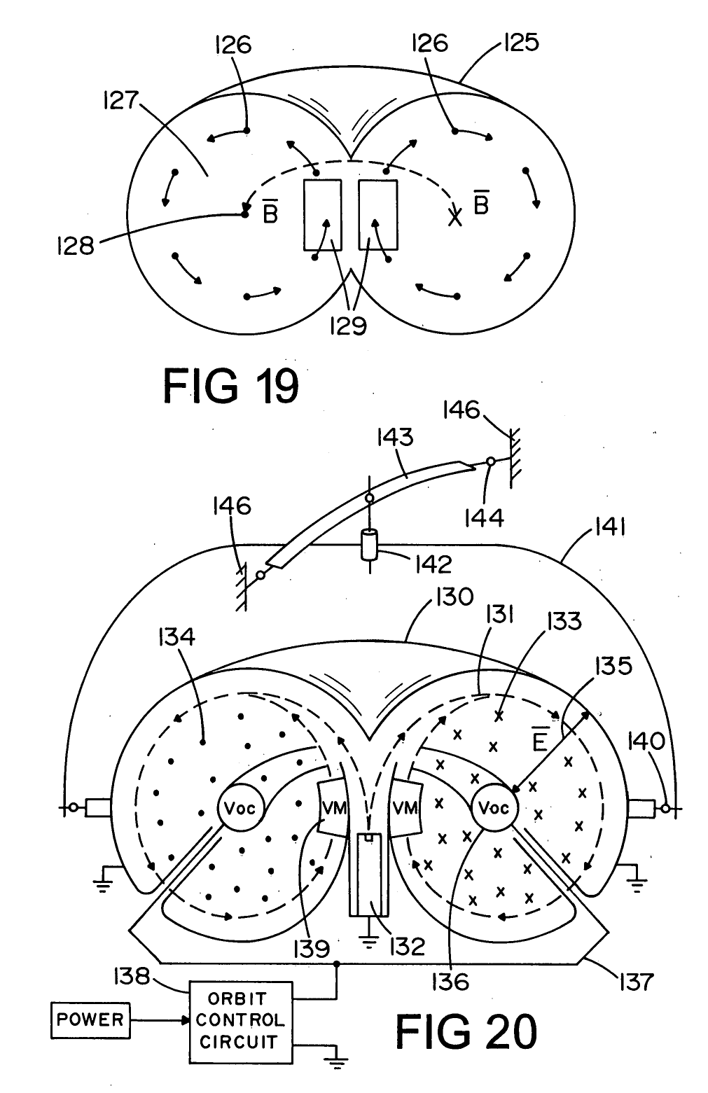

FIG. 19 shows a cutaway view of a more elegant mechanical design for the torrid, where, by one example, a single torroidal housing 125 can replace the plurality of individual circular tracks 125. In this embodiment of the invention, a continuous stream of charged-particles 126 (a plasma) rotates in a circular motion. The thruster effect is the same as shown in FIG. 18, but the unit is easier to construct since there is a single donut shaped housing 125. Magnetic Field “B” is shown now in cross-sectional view, pointing into the page and coming out of the page 128. Many charged particles 126 are depicted rotating at very high velocities. Velocity modifier devices 129 are attached to the torroid shell 125 and can be shaped and positioned as needed to slow the particles, yielding thrust from the device. A high-grade Vacuum is maintained inside the interior of the shell 127 so that the high speed particles do not collide with air molecules or other substances that might slow down their velocity.

Referring now to FIG. 20, a more practical version of the torroidal (donut) inertiatron is shown in cross sectional cut-away view. Light-weight torroidal casing 130 contains a continuous charged particle stream 131, moving at relativistic, or near relativistic velocities. Particle gun 132 is the source of these charged particles, by way of example, electrons, protons, or other ions. The total mass content of the particle stream is increased over time, causing some negative thrust output. This is in keeping with prior teachings that during the charging sub-cycle or “first giant half-cycle” the particle gun accelerates the inner mass stream to a high rotational velocity. The acceleration of the inner mass stream of charged particles produces a counter force that is transferred to the vehicle frame 146 through the gimbal structure 140-144 and eventually to the surface of the earth that the vehicle is resting on before flight. Gimbal structure 140-144 is used to attach the inertiatron to the vehicle in a manner that allows the attitude of the vehicle to roll, pitch or yaw without disturbing the attitude of the inertiatron.

Continuing to refer to FIG. 20, magnetic field 133 is created by the circular path of charged particles 131. Field 133 is drawn with an “X” since the field is pointing into the page. Magnetic field 134 is the same magnetic field as magnetic field 133 but shown from the left-side cut-away view of the torroid. Magnetic field 134 is drawn as a “dot” since the field in this region of the torroid is pointing out of the page. Those skilled in the art of particle accelerator devices will concur that keeping particles such as electrons or protons in controlled streams for any length of time is historically difficult. For that reason, an orbit control circuit 138 is added to the torroid inertiatron. Orbit control circuit 138 generates a continuously varying voltage Voc (the orbit-control Voltage) which is connected via wires or other conductors 137 to the Voc conductive ring which is shown running through the middle of the torroid. The surface of the Voc control ring is brought to the potential voltage Voc, creating a uniform electric field lines “E” 135, between the inner skin of the torrid housing 130 and the outer surface of the Voc ring. This electric field imparts an inward pulling force to the particle stream, however not as strong of a pulling force as the force generated by the magnetic field 133/134. By varying voltage Voc using electrical feed-back networks built into the orbit control circuit 138, the particle stream can be kept steady and contained to a radius that is not too small, and not to big, so as to prevent collision of the particles into the inner walls of the housing, or into the orbit control ring.

Continuing to refer to FIG. 20, the particle streams passes through velocity modifiers 139 which act as particle braking devices. The velocity modifiers decelerate the particle stream, resulting in an upward reaction force against the velocity modifiers, which is transmitted to the torrid housing 130, and then into vehicle 146 by way of gimbal mount structures 140-144. When the starting velocity of the particles is high, and the particle stream is charged up to sufficient mass density, the total braking time required to slow all of the particles to zero velocity can range from several minutes to several hours. A plurality of torroid inertiatrons can be used together in ganged arrays to provide propulsion or lifting of vehicles weighing thousands of pounds.

The described devices, with the exception of the thrust device of FIG. 1, employ closed loop rotating paths. However, inertiatrons can also be constructed that have inner masses following a reciprocating path, such as inner masses going back-and-forth along a linear path. In these embodiments, rebound structures at the ends of the linear path provide substantially elastic rebounding for the inner masses.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

I claim:

1. An apparatus comprising a thruster including a mass following a trajectory confined to a preselected volume, and a brake selectively applied to selectively decelerate or accelerate the mass over a selected portion of the trajectory.

2. The apparatus as set forth in claim 1, further comprising a housing defining the preselected volume, the brake being secured to the housing.

3. The apparatus as set forth in claim 2, further comprising a track disposed inside the housing and secured to the housing, the track constraining the mass to follow the trajectory.

4. The apparatus as set forth in claim 1, wherein the brake has a braking mode in which the brake decelerates the mass over the selected portion of the trajectory, and an accelerating mode in which the brake accelerates the mass over the selected portion of the trajectory.

5. The apparatus as set forth in claim 4, wherein the brake comprises a decelerator operative when the brake is in the braking mode; and an accelerator operative when the brake is in the accelerating mode.

6. The apparatus as set forth in claim 4, wherein the apparatus further comprises a first plurality of thrusters; and a second plurality of thrusters; the brakes of the first plurality of thrusters being in the accelerating mode when the brakes of the second plurality of thrusters are in the decelerating mode; and the brakes of the second plurality of thrusters being in the accelerating mode when the brakes of the first plurality of thrusters are in the decelerating mode.

7. The apparatus as set forth in claim 4, wherein the apparatus comprises a plurality of thrusters and further comprises a support, the brakes of the plurality of thrusters being secured to the support and exerting a force on the support during the accelerating or decelerating.

8. The apparatus as set forth in claim 7, wherein the brakes of the plurality of thrusters are secured to the support such that a net force exerted on the support with the brakes in the accelerating mode is substantially zero, and a non-zero net thrust force is exerted on the support with the brakes in the decelerating mode.

9. The apparatus as set forth in claim 4, wherein the apparatus comprises a plurality of groups of thrusters and further comprises a support, the brakes of each group of thrusters being secured to the support and exerting a brake force on the support during the accelerating or decelerating, the brakes of each thruster of each group of thrusters being configured so that the brake force exerted on the support by each group of thrusters is substantially zero with the brakes of the group of thrusters in the accelerating mode, and a group thrust force with the brakes of the group of thrusters in the decelerating mode; and timing circuitry selectively switching the plurality of groups of thrusters to apply thrust to the support using at least one group of thrusters while at least one other group of thrusters has its brakes in the accelerating mode.

10. The apparatus as set forth in claim 1, further comprising a throttle controlling the brake between zero deceleration and a maximum deceleration.

11. The apparatus as set forth in claim 10, wherein the throttle controls the brake to provide a deceleration selected from a continuum of decelerations ranging between zero deceleration and the maximum deceleration.

12. The apparatus as set forth in claim 1, further comprising a throttle controlling the brake between a maximum deceleration over the selected portion of the trajectory and a maximum acceleration applied to the mass over the selected portion of the trajectory.

13. The apparatus as set forth in claim 1, further comprising a first plurality of thrusters with brakes secured to a common support; and a throttle selectively applying a fraction of the brakes to produce a selected counter-force acting on the common support.

14. The apparatus as set forth in claim 1, wherein the mass comprises a plurality of charged particles.

15. The apparatus as set forth in claim 14, wherein the brake comprises an electrostatic brake electrostatically decelerating the mass over the selected portion of the trajectory.

16. The apparatus as set forth in claim 14, wherein the brake comprises a magnetic brake magnetically decelerating the mass over the selected portion of the trajectory.

17. The apparatus as set forth in claim 14, further comprising a confinement device that generates a confining magnetic field constraining the plurality of charged particles to follow the trajectory.

18. The apparatus as set forth in claim 14, further comprising a confinement device that generates a confining electrostatic field constraining the plurality of charged particles to follow the trajectory.

19. The apparatus as set forth in claim 1, further comprising an evacuated housing enclosing at least the trajectory; and an electron source sourcing a plurality of accelerated electrons defining the mass.

20. The apparatus as set forth in claim 19, further comprising a substrate disposed in the evacuated housing and having an electrically biased track disposed thereon, the track constraining the accelerated electrons to follow the trajectory.

21. The apparatus as set forth in claim 1, further comprising a track defining the trajectory, the track being selected from a group consisting of a semiconductor track, a metal track, a track made of an electrically superconducting material, and an evacuated hollow track.

22. The apparatus as set forth in claim 1, wherein the apparatus includes a plurality of thrusters and further comprises a common support, the brakes of the thrusters being substantially rigidly secured to the common support.

23. The apparatus as set forth in claim 22, wherein each thruster further comprises a confinement disposed on the common support, the confinement restricting the mass to follow the trajectory.

24. The apparatus as set forth in claim 23, wherein the common support comprises a plurality of generally planar substrates that are secured together.

25. The apparatus as set forth in claim 1, wherein the apparatus includes a plurality of thrusters and further comprises a vehicle, the plurality of thrusters being operatively connected with the vehicle to propel the vehicle.

26. The apparatus as set forth in claim 25, wherein the vehicle is selected from a group consisting of: a wheeled vehicle, an airplane, a boat, a ship, a submarine, and a spacecraft.

27. The apparatus as set forth in claim 25, wherein the apparatus further comprises a substantially rigid support onto which the plurality of thrusters are secured, the brake of each thruster applying a force to the support in a selected direction when the brake is applied; and an rotatable or gimbal mount connecting the support to the vehicle, the rotatable or gimbal mount selectively angularly positioning the support relative to the vehicle.

28. The apparatus as set forth in claim 1, wherein the apparatus includes a plurality of thrusters and further comprises a support onto which the plurality of thrusters are secured, the brake of each thruster being substantially rigidly secured to the support, the brakes of the thrusters cooperatively thrusting the support in a selected direction.

29. The apparatus as set forth in claim 28, further comprising a parachute defined at least by the support and the plurality of thrusters, the parachute being adapted to attach to an associated subject.

30. The apparatus as set forth in claim 28, further comprising an elevator car, the support being secured to the elevator car to provide a lifting force to the car.

31. The apparatus as set forth in claim 1, wherein the trajectory defines a generally planar closed loop and the mass following the trajectory causes the thruster to have a moment of inertia generally transverse to the generally planar closed loop and generally transverse to a direction of the deceleration.

32. The apparatus as set forth in claim 1, wherein the mass comprises at least one billion masses following the trajectory.

33. A method for applying thrust to an associated object, the method comprising accelerating a plurality of masses along one or more trajectories confined within a selected volume; and repeatedly decelerating each of the moving masses, the decelerating producing a counter-force applied to the associated object.

34. The method as set forth in claim 33, wherein the accelerating of a plurality of masses along one or more trajectories confined within a selected volume comprises accelerating a plurality of charged particles; and at least one of electrostatically and magnetically confining the accelerated electrons along one or more closed trajectories.

35. The method as set forth in claim 34, wherein the repeated decelerating comprises applying at least one of a decelerating electric field and a decelerating magnetic field to a portion of the one or more closed trajectories.

36. The method as set forth in claim 34, wherein the accelerating comprises at least one of electrically and magnetically accelerating the masses in a direction opposite the decelerating direction, the repeated decelerating being omitted during the accelerating.

37. The method as set forth in claim 36, further comprising transferring counter-forces produced by the accelerating to the associated object in a substantially force balanced arrangement such that a net counter-force on the associated object during the accelerating is negligible.

38. The method as set forth in claim 36, further comprising alternating between the repeated decelerating and the accelerating, wherein at least some masses are being repeatedly decelerated while other masses are being accelerated at any given time.

39. An inertiatron comprising a plurality of masses moving along one or more pre-defined closed paths.

40. The inertiatron as set forth in claim 39, including micro-electromechanical (MEMS) masses moving along one or more pre-defined closed paths.

41. The inertiatron as set forth in claim 39, including relativistic particles moving along closed paths.

42. The inertiatron as set forth in claim 39, including a brake slowing the masses over a portion of the pre-defined closed path.

43. The inertiatron as set forth in claim 42, the masses comprise an effective number of masses for providing substantially uniform thrust when the brake is applied.

44. The inertiatron as set forth in claim 43, where a plurality of circular or oval closed paths containing charged particles is arranged in a torroidal overall shape, such that the magnetic field generated by the summation of all track interactions stays confined within the torroid and aids in producing a confining force to keep the particles in their tracks.
